(19) United States
(12) Patent Application Publication
(10) Pub. No.: US 2026/0349317 A1
(43) Pub. Date: Nov. 5, 2026

(54) OPTICAL SYSTEM AND CAMERA MODULE

(71) Applicant: LG INNOTEK CO., LTD., Seoul (KR)

(72) Inventor: Sung Min MOON, Seoul (KR)

(21) Appl. No.: 19/487,814

(22) PCT Filed: May 27, 2024
(86) PCT No.: PCT/KR2024/007162

§ 371 Date: Nov. 25, 2025

(30) Foreign Application Priority Data
May 25, 2023 (KR) 10-2023-0067547

(51) Int. Cl. G03B 17/17; G03B 13/36

(52) U.S. Cl. CPC G03B 17/17; G03B 13/36

(57) ABSTRACT

The camera module disclosed in the embodiment of the invention includes a reflective member having a reflective surface; a first lens group having a plurality of lenses; and a second lens group disposed on the sensor side of the first lens group, and having a plurality of lenses and negative power, the reflective member and the lenses of the first and second lens groups are aligned along an optical axis, the first lens group includes a first lens having a maximum effective length, an object-side surface of the first lens is convex on the optical axis, the second lens group includes a lens having concave sides on the optical axis, the optical axis distance from the object-side surface of the first lens to the surface of the image sensor is TTL, the optical axis distance from the sensor-side surface of the last lens closest to the image sensor to the surface of the image sensor is BFL, the optical axis distance from the object-side surface of the first lens to the sensor-side surface of the last lens is TD, and the following mathematical expressions satisfies: 0.2<BFL/TTL<1 and 1<TTL/TD<3.

### TECHNICAL FIELD

An embodiment of the invention relates to an optical system for improved optical performance and a camera module including the same.

### BACKGROUND ART

The camera module captures an object and stores it as an image or video, and is installed in various applications. In particular, the camera module is produced in a very small size and is applied to not only portable devices such as smartphones, tablet PCs, and laptops, but also drones and vehicles to provide various functions. For example, the optical system of the camera module may include an imaging lens for forming an image, and an image sensor for converting the formed image into an electrical signal. In this case, the camera module may perform an autofocus (AF) function of aligning the focal lengths of the lenses by automatically adjusting the distance between the image sensor and the imaging lens, and may perform a zooning function of zooming up or zooning out by increasing or decreasing the magnification of a remote object through a zoom lens. In addition, the camera module employs an image stabilization (IS) technology to correct or prevent image stabilization due to an unstable fixing device or a camera movement caused by a user's movement.

The most important element for this camera module to obtain an image is an imaging lens that forms an image. Recently, interest in high efficiency such as high image quality and high resolution is increasing, and research on an optical system including plurality of lenses is being conducted in order to realize this. For example, research using a plurality of imaging lenses having positive (+) and/or negative (−) refractive power to implement a high-efficiency optical system is being conducted. An optical system including multiple lenses may have a set effective focal length (EFL). If the EFL value is relatively large, the lens closest to the object may have a large aperture, or the largest aperture among the multiple lenses. Consequently, the lens closest to the object may have a relatively large size, making it difficult to miniaturize the optical system.

An optical system including multiple lenses may also have a relatively large height. For example, as the number of lenses increases, a distance from the image sensor to the object-side surface of the lens closest to the object may increase. Consequently, the overall thickness of a device, such as a smartphone, in which the optical system is installed may increase, making miniaturization difficult. Camera modules for near-range photography have shorter TTLs than conventional camera modules. For example, camera modules for far-range photography have longer TTLs than conventional camera modules. However, portable terminals have limited space for camera modules, making it difficult to incorporate long-range camera modules or camera modules capable of adjusting image magnification (Zoom camera module). Therefore, a new optical system capable of resolving the aforementioned issues is required.

### DISCLOSURE

### Technical Problem

An embodiment of the invention provides an optical system and camera module with improved optical characteristics. An embodiment of the invention provides an optical system that may be implemented in a small and compact manner. An embodiment of the invention provides a zoom lens optical system by moving a lens group adjacent to a sensor among a plurality of lens groups. An embodiment of the invention provides an optical system in which at least one lens adjacent to an object side or an outside of a terminal among a plurality of lenses has different lengths in a first direction and a second direction. An embodiment of the invention provides an optical system applicable to a folded camera or teletype having a thin thickness or height.

### Technical Solution

A camera module according to an embodiment of the invention comprises: a reflective member having a reflective surface; a first lens group having a plurality of lenses; and a second lens group disposed on a sensor side of the first lens group, having a plurality of lenses and having negative power, wherein the reflective member, the lenses of the first lens group, and the lenses of the second lens group are aligned along the optical axis, the first lens group includes a first lens having a maximum effective length, an object-side surface of the first lens has a convex shape on the optical axis, the second lens group includes lenses having a shape in which both sides are concave on the optical axis, an optical axis distance from the object-side surface of the first lens to a surface of the image sensor is TTL, an optical axis distance from a sensor-side surface of the last lens closest to an image sensor to the surface of the image sensor is BFL, and an optical axis distance from the object-side surface of the first lens to the sensor-side surface of the last lens is TD, and the following mathematical expressions satisfy: 0.2<BFL/TTL<1 and 1<TTL/TD<3.

According to an embodiment of the invention, the second lens group may move along the optical axis. The amount of movement of the second lens group is M1, and may satisfy the mathematical expression: 0.1 mm<M1<3 mm. When the distance between the first lens and the subject is 800 mm or more, the amount of movement of the second lens group may satisfy the mathematical expression: 0.1 mm<M1<0.9 mm. A field of view of the camera module is less than 40 degrees. The field of view of the camera module is less than 40 degrees, and an amount of change in the field of view according to the maximum movement of the second lens group may be 5 degrees or less.

According to an embodiment of the invention, when a distance from the subject gradually decreases during photographing, an optical axis distance between the first lens group and the second lens group may gradually increase. When the distance from the subject gradually decreases during photographing, the BFL may gradually decrease. When taking a photographing at a minimum distance from the subject, the optical axis distance between the first and second lens groups is Max_CG3′, and the optical axis distance between the last lens and the surface of the image sensor is Min_BFL1, and the following mathematical expression may satisfy: 0.5<Min_BFL1/Max_CG3′<1.5.

A camera module according to an embodiment of the invention comprises: a reflective member having a reflective surface; a first lens having positive power on an exit side of the reflective member; a second lens on a sensor side of the first lens; a third lens having negative power on a sensor side of the second lens; a fourth lens on a sensor side of the third lens; and a fifth lens on a sensor side of the fourth lens, wherein the reflective member and the first to fourth lenses are aligned along the optical axis, the powers of the fourth lens and the fifth lens have opposite signs, the first lens has a maximum effective length and includes an object-side surface having a convex shape on the optical axis, the fourth lens has a shape in which both sides are concave on the optical axis, a field of view of the optical system having the first to fifth lenses is less than 40 degrees, an optical axis distance from a center of the object-side surface of the first lens to a surface of the image sensor is TTL, and ½ of the diagonal length of the image sensor is ImgH, and an optical axis distance between the third lens and the fourth lens may vary from a minimum of CG3 to a maximum of Max_CG3′, and may satisfy mathematical expressions: 1.5<Max_CG3′/CG3<3 and 2<TTL/ImgH<6.

According to an embodiment of the invention, the first to third lenses may have a convex meniscus shape toward an object on the optical axis. The fourth lens may have negative power, and the fifth lens may have positive power. The optical axis distance between the sensor-side surface of the fifth lens and the image sensor may vary depending on the optical axis distance between the third lens and the fourth lens. The maximum optical axis distance between the sensor-side surface of the fifth lens and the image sensor is BFL, and may satisfy the mathematical expression: 1<BFL/ImgH<4. The maximum optical axis distance between the sensor-side surface of the fifth lens and the image sensor is BFL, and may satisfy the mathematical expression: 0.2<BFL/TTL<1. The maximum optical axis distance between the sensor-side surface of the fifth lens and the image sensor is BFL, and may satisfy the mathematical expression: 2<BFL/CG3<5.

According to an embodiment of the invention, the maximum of the effective lengths of the object-side surface and the sensor-side surface of the first to fifth lenses is CA_Max, and may satisfy the mathematical expression: 2<TTL/CA_Max<6. The amount of movement of the fourth and fifth lenses is M1, and when the distance from the subject is 800 mm or more, the mathematical expression may satisfy: 0.1 mm<M1<0.9 mm. An aperture stop disposed on the periphery of the object-side surface or the sensor-side surface of the third lens may be included, and the amount of change in the field of view according to the movement of the fourth and fifth lenses may be 5 degrees or less. According to an embodiment of the invention, when photographing at a minimum distance from the subject, the optical axis distance between the third and fourth lenses is Max_CG3′, and the optical axis distance between the fifth lens and the surface of the image sensor is Min_BFL1, and may satisfy the mathematical expression: 0.5<Min_BFL1/Max_CG3′<1.5.

### Advantageous Effects

An optical system and camera module according to an embodiment may have various magnifications and exhibit excellent optical characteristics when providing various magnifications. Specifically, the embodiment can control the movement distance of each of the moving lens groups to achieve various magnifications and provide an autofocus (AF) function for a subject. The optical system and camera module according to an embodiment can compensate for aberration characteristics of multiple lens groups or mutually complement aberration characteristics that change due to movement. Accordingly, the optical system according to an embodiment can minimize or prevent changes in chromatic aberration and aberration characteristics that occur when magnification changes.

The optical system and camera module according to an embodiment can control the effective focal length (EFL) by moving only some of the multiple lens groups and minimize the movement distance of the moving lens groups. Accordingly, the optical system can reduce the movement distance of the moving lens groups according to changes in the operation mode and minimize power consumption required when the lens groups are moved. The optical system may have at least one lens included in the fixed group and the moving group having a non-circular shape. Accordingly, the optical system can reduce its height while maintaining optical performance, and secure space for structurally arranging lens groups between multiple lens groups.

The optical system and camera module according to the embodiment can adjust magnification by moving a lens group other than the first lens group adjacent to the subject among the multiple lens groups. Accordingly, the optical system can maintain a constant TTL value even when the lens groups are moved due to changes in magnification. Consequently, the optical system and the camera module including the optical system may be provided with a slimmer structure.

### DESCRIPTION OF DRAWINGS

FIG. 1 is a side cross-sectional view of a camera module having an optical system according to an embodiment of the invention.

FIG. 2 is a side cross-sectional view of the optical system of FIG. 1 and a camera module having the same, according to a first embodiment of the invention.

FIG. 3 is an example of a plan view of the object-side and sensor-side surfaces of the first lens in the optical system of FIG. 2.

FIG. 4 is a table showing the characteristics of the lenses in the optical system of FIG. 2.

FIG. 5 shows the aspherical coefficients of the object-side and sensor-side surfaces of the lenses in FIG. 2.

FIG. 6 is a diagram comparing the second lens group of the optical system of FIG. 2 before and after movement.

FIG. 7 is a graph showing data on ray aberrations of the optical system of FIG. 1.

FIG. 8 is a graph showing data on spherical aberration, astigmatism, and distortion characteristics of the optical system of FIG. 1.

FIG. 9 is a side cross-sectional view of the optical system of FIG. 1 and a camera module including the same, according to a second embodiment of the invention.

FIG. 10 is a table showing the characteristics of the lenses of the optical system of FIG. 9.

FIG. 11 shows the aspherical coefficients of the object-side and sensor-side surfaces of the lenses of FIG. 9.

FIG. 12 is a graph showing data on ray aberrations of the optical system of FIG. 9.

FIG. 13 is a graph showing data on spherical aberration, astigmatism, and distortion characteristics of the optical system of FIG. 9.

FIG. 14 is a side cross-sectional view of the optical system of FIG. 1 and a camera module including the same, according to a third embodiment of the invention.

FIG. 15 is a table showing the characteristics of the lenses of the optical system of FIG. 14.

FIG. 16 shows the aspherical coefficients of the object-side and sensor-side surfaces of the lenses of FIG. 14.

FIG. 17 is a graph showing data on ray aberrations of the optical system of FIG. 14.

FIG. 18 is a graph showing data on spherical aberration, astigmatism, and distortion characteristics of the optical system of FIG. 14.

FIG. 19 is an example of a mobile terminal having an optical system according to an embodiment of the invention.

### BEST MODE

Hereinafter, preferred embodiments of the invention will be described in detail with reference to the accompanying drawings. A technical spirit of the invention is not limited to some embodiments to be described, and may be implemented in various other forms, and one or more of the components may be selectively combined and substituted for use within the scope of the technical spirit of the invention. In addition, the terms (including technical and scientific terms) used in the embodiments of the invention, unless specifically defined and described explicitly, may be interpreted in a meaning that may be generally understood by those having ordinary skill in the art to which the invention pertains, and terms that are commonly used such as terms defined in a dictionary should be able to interpret their meanings in consideration of the contextual meaning of the relevant technology.

The terms used in the embodiments of the invention are for explaining the embodiments and are not intended to limit the invention. In this specification, the singular forms also may include plural forms unless otherwise specifically stated in a phrase, and in the case in which at least one (or one or more) of A and (and) B, C is stated, it may include one or more of all combinations that may be combined with A, B, and C. In describing the components of the embodiments of the invention, terms such as first, second, A, B, (a), and (b) may be used. Such terms are only for distinguishing the component from other component, and may not be determined by the term by the nature, sequence or procedure etc. of the corresponding constituent element. And when it is described that a component is “connected”, “coupled” or “joined” to another component, the description may include not only being directly connected, coupled or joined to the other component but also being “connected”, “coupled” or “joined” by another component between the component and the other component. In the case of being described as being formed or disposed “above (on)” or “below (under)” of each component, the description includes not only when two components are in direct contact with each other, but also when one or more other components are formed or disposed between the two components. In addition, when expressed as “above (on)” or “below (under)”, it may refer to a downward direction as well as an upward direction with respect to one element.

In the description of the invention, the “object-side surface” may mean a surface of the lens facing the object side based on the optical axis OA, and the “sensor-side surface” may mean a surface of the lens facing the imaging surface (image sensor) based on the optical axis. A convex surface of the lens may mean a convex shape in the optical axis or the paraxial region, and a concave surface of the lens may mean a concave shape in the optical axis or the paraxial region. The curvature radius, center thickness, focal length, and optical axis distance between lenses described in the table for lens data mean values in the optical axis and are in mm. The vertical direction may mean a direction perpendicular to the optical axis, and the end of the lens or lens surface may mean the end of the effective area of the lens through which incident light passes. The size of the effective diameter or curvature radius of the lens surface may have a measurement error of up to ±0.4 mm depending on the measurement method, etc. The paraxial region means a very narrow region near the optical axis, a region where the distance a light ray falls from the optical axis OA is almost 0. Hereinafter, the optical axis may include the center of each lens or a very narrow region near the optical axis.

An optical system is composed of multiple lenses having refractive power. However, an optical system is not limited to lenses having refractive power. For example, an optical system may include a aperture stop ST for controlling the amount of light. Additionally, an optical system may include a filter for blocking infrared rays. Additionally, an optical system may further include an image sensor (i.e., an imaging element) for converting an image of an object incident through the optical system into an electrical signal. Additionally, an optical system may further include a distance member for adjusting the distance between lenses.

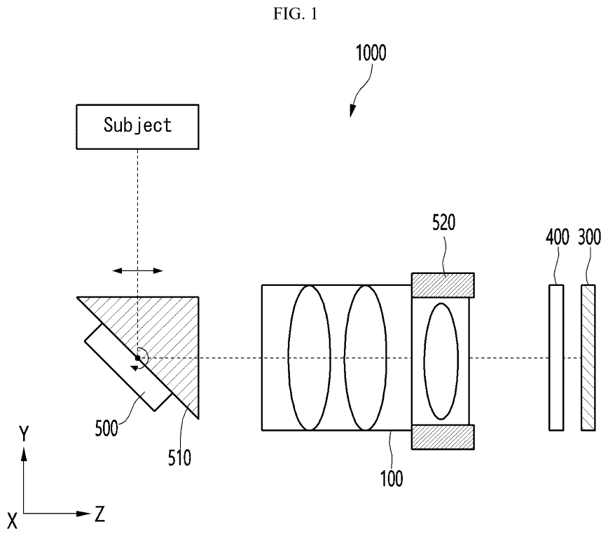

FIG. 1 is a side cross-sectional view of a camera module having an optical system according to an embodiment of the invention.

Referring to FIG. 1, a camera module 1000 according to an embodiment may include a lens unit 100, an image sensor 300, and a reflective member 510. The lens unit 100 is disposed on the exit side of the reflective member 510 and may be disposed on a path along which light reflected from a subject or the reflective member 510 moves. The lens unit 100 may include a plurality of lenses. The lens unit 100 may be accommodated in a housing or a lens barrel. The plurality of lenses may be made of glass, plastic, or a mixture of glass and plastic lenses. The plurality of lenses may be sequentially disposed along the optical axis of the lens unit 100 from the subject side toward the sensor side. The optical axis of the lens unit 100 may be perpendicular to the imaging surface of the image sensor 300.

The lens unit 100 may control the path of light reflected from the subject. For example, each of the plurality of lenses may have positive (+) or negative (−) refractive power and may have a set shape and thickness. Accordingly, the lens unit 100 may control the path of light reflected from the subject by diffusing, scattering, refracting, or focusing the light. The lens unit 100 may have a set field of view (FOV). Additionally, the lens unit 100 may have a set effective focal length (EFL). The EFL of the lens unit 100 may be variable within a set range. The image sensor 300 may be disposed on the path of light reflected from the subject. For example, the lens unit 100 may be disposed between the subject and the image sensor 300.

The image sensor 300 may be disposed on a substrate (not shown). The substrate may be electrically connected to the image sensor 300 and may physically support it. The substrate may be a circuit board. The substrate may include a wiring layer for supplying power to the image sensor 300 and may be a printed circuit board (PCB) formed of a plurality of resin layers. For example, the substrate may include at least one of a rigid PCB, a metal core PCB (MCPCB), a flexible PCB (FPCB), and a rigid flexible PCB (RFPCB). The image sensor 300 may detect light reflected from the subject and incident on the camera module 1000. The image sensor 300 can detect light passing through the lens unit 100. Specifically, the image sensor 300 can detect light sequentially passing through the plurality of lenses. The image sensor 300 may include a charge coupled device (CCD) or a complementary metal oxide semiconductor (CMOS).

The reflective member 510 may be disposed on the path of light reflected from the subject. The reflective member 510 may be positioned closer to the subject than the lens unit 100. That is, the reflective member 510, the lens unit 100, and the image sensor 300 may be positioned in this order from the subject toward the image side. The reflective member 510 can change the path of externally incident light. The reflective member 510 may include a reflector or a prism. For example, the prism may include a right-angle prism. If the reflective member 510 is a right-angle prism, the reflective member 510 can reflect the path of light incident on the camera module 1000 at a 90-degree angle. The reflective member 510 can change the path of light reflected on the subject into a set direction. For example, the reflective member 510 may reflect light incident on the reflective member 510 in a second direction (Y-axis direction) and change the path of the light to a third direction (Z-axis direction), which is the direction in which the multiple lenses of the lens unit 100 are arranged.

Since the camera module 1000 includes the reflective member 510, it may be applied to a folded camera capable of reducing the thickness in the second direction (Y-axis). If the camera module 1000 does not include the reflective member 510, the plurality of lenses of the lens unit 100 within the device may extend in a direction perpendicular to the surface of the device. Accordingly, the camera module 1000 including the plurality of lenses may have a high height in the direction Y perpendicular to the surface of the device, which may make it difficult to form the camera module 1000 and the device including the same thin. However, since the camera module 1000 includes the reflective member 510, the camera module 1000 may reflect light incident in a direction perpendicular to the surface of the device to which it is applied, and the reflected light may be transmitted in a direction parallel to the surface of the device. That is, the plurality of lenses of the lens unit 100 may be stacked in a direction parallel to the surface of the device, and the optical axis of the lenses may be parallel to the surface of the device. Accordingly, the camera module 1000 including the lens unit 100 may have a low height in a direction perpendicular to the surface of the device, thereby having a thinner thickness within the device, and thus, the thickness of the device may also be thinner.

The first driving member 500 may be connected to the reflective member 510. The first driving member 500 may include at least one actuator. For example, the first driving member 500 may include at least one of a voice coil motor (VCM), a piezoelectric device, a shape memory alloy, and a MEMS device as the actuator. The first driving member 500 may move the reflective member 510 using the driving force of the actuator. For example, the first driving member 500 can tilt-control the reflective member 510 about the first axis or the second axis. Specifically, the first driving member 500 may tilt-control the reflective member 510 about the second direction (Y-axis direction) as the rotation axis. In addition, the first driving member 500 may tilt-control the reflective member 510 about the third direction (X-axis direction) as the rotation axis. Accordingly, the camera module 1000 can compensate for shaking.

The camera module 1000 includes a detection unit (not shown) that detects shaking, and the detection unit may be a sensor that detects rotation and positional changes applied to the camera module 1000. The sensing unit may include at least one of a sensor that detects changes in angular velocity, for example, a gyro sensor, and an acceleration sensor that detects changes in acceleration.

The lens unit 100 may include multiple lens groups, each of which may include at least one lens. The second driving member 520 may move any one of the lens groups within the lens unit 100 in the optical axis direction. For example, the second driving member 520 may move a lens group adjacent to the image sensor 300 in the optical axis direction.

The second driving member 520 may include at least one actuator. For example, the second driving member 520 may include at least one actuator selected from the group consisting of a VCM, a piezoelectric element, a shape memory alloy, and a MEMS element. The second driving member 520 may move or restore the moving lens group toward the prism using the driving force of an actuator having opposing magnets and coils. The second driving member 520 may move at least one lens group to adjust the focal length, thereby enlarging or reducing the subject.

The camera module 1000 may include a filter 400. The filter 400 is an optical filter and may be disposed between the lens unit 100 and the image sensor 300. Specifically, the filter 400 may be disposed between the lens closest to the image sensor 300 among the multiple lenses of the lens unit 100 and the image sensor 300. As another example, the filter 400 may be disposed between the lenses. The filter 400 may include at least one optical filter, such as an infrared filter or a cover glass. The filter 400 can pass light within a set wavelength band and filter out light within a different wavelength band. If the filter 400 includes an infrared filter, it can block radiant heat emitted from external light from reaching the image sensor 300. Furthermore, the filter 400 can transmit visible light and block infrared light.

The camera module 1000 can control the movement of the reflective member 510 via a control signal. Specifically, if the camera module 1000 experiences shaking, the camera module can detect information about the shaking, such as the degree of rotation and positional changes of the sensors, and perform compensation for the shaking. Furthermore, the second driving member 520 may be controlled via a driving signal to control the movement of the movable lens group, detect positional changes, and vary the focal length. The reflective member 510 is connected to the first driving member 500 and may be tilted about at least one of the second direction (Y-axis direction) and the first direction (X-axis direction) as the rotation axis. Accordingly, the camera module 1000 can compensate for shaking due to rotation.

The camera module 1000 according to the embodiment can set the tilt angle of the reflective member 510 and the position of the image sensor 300 based on the angular velocity and acceleration change amount detected by the detection unit. At this time, the tilt angle of the reflective member 510 may be set through rotation due to shaking, and the movement distance of the image sensor 300 may be set through position change due to shaking. Accordingly, when photographing a subject located at an infinite or near distance using the camera module 1000 according to the embodiment, shaking due to rotation and position change may be effectively corrected. As another example, the image sensor 300 is connected to a third driving member (not shown), and the position of the image sensor 300 may be controlled. For example, the third driving member may move the image sensor 300 in at least one of the second direction (Y-axis direction) and the first direction (X-axis direction). The image sensor 300 can compensate for positional changes caused by the shaking of the camera module 1000 by the driving force of the third driving member. Furthermore, the image sensor 300 may move in at least one of the second direction (Y-axis direction) and the first direction (X-axis direction) in response to an applied control signal, thereby compensating for the shaking caused by the positional change.

Therefore, the camera module 1000 according to the embodiment can effectively compensate for rotational shaking and positional shaking when photographing a subject located at infinity or a near distance. Therefore, the camera module 1000 may have improved optical characteristics.

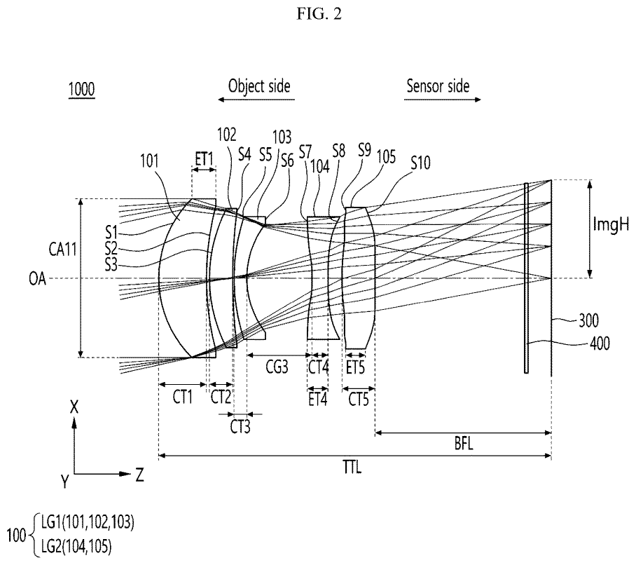

Referring to FIGS. 2, 9, and 14, the lens unit 100 according to the embodiments of the invention may include multiple lens groups LG1 and LG2. Specifically, each of the multiple lens groups LG1 and LG2 includes at least one lens. For example, the camera module 1000 may include a first lens group LG1 and a second lens group LG2 sequentially arranged along the optical axis OA from the object side toward the image sensor 300.

The number of lenses in each of the first lens group LG1 and the second lens group LG2 may be different. The number of lenses in the first lens group LG1 may be greater than the number of lenses in the second lens group LG2, and may be, for example, more than one or less than two times the number of lenses in the second lens group LG2. The lens unit 100 may include n lenses, wherein the lens closest to the subject is the first lens 101, 111 and 121, the n-th lens is the lens closest to the image sensor 300, and the n−1th lens may be the object-side lens closest to the n-th lens. The n is an integer less than or equal to 6, for example, 4 to 6. The first lens group LG1 is disposed on the exit side of the reflective member 510 and may include at least two lenses. The first lens group LG1 may have three or less lenses, for example, three lenses. The second lens group LG2 may include one or more lenses, for example, one to three lenses, and preferably two lenses.

At least one or all of the first lens group LG1 may include a plastic lens. The first lens group LG1 may provide the first lens 101, 111 and 121 closest to the subject or reflective member 510 as a plastic lens. The second lens group LG2 may include at least one or all of the plastic lenses. This plastic material can adjust the thickness or curvature radius of each lens, thereby controlling the refractive power of the incident light of each lens.

At least one or both of the lenses in the first lens group LG1 may include an aspherical lens. At least one or both of the lenses in the second lens group LG2 may include an aspherical lens. By arranging the aspherical lenses within the lens unit 100, the occurrence of various aberrations may be suppressed. The aspherical lenses are lenses having an aspherical shape on the object-side surface and/or the sensor-side surface. Since the first lens 101, 111 and 121 is disposed on the output side of the reflective member 510 and is provided as an aspherical lens, the thickness of the first lens 101, 111 and 121 may be thinner than that of a spherical lens, and the chromatic dispersion may be reduced for a short TTL, while image distortion in the peripheral region may be reduced. All lenses of the camera module 1000 may be plastic lenses. The TTL (Total Track Length) is the optical axis distance from the center of the object-side surface of the first lens 101, 111 and 121 to the surface or imaging plane of the image sensor 300. As another example, at least one of the lenses may be made of glass or a spherical lens. For example, the first lens 101, 111 and 121 may be made of glass, for example, may be made of UV-blocking glass, and may have a spherical or aspherical surface.

An embodiment of the invention may move either of the first and second lens groups LG1 and LG2. For example, the second lens group LG2 may be moved to provide a lens optical system, such as continuous zoom. That is, the second lens group LG2 may be moved to capture images from infinity to a near distance (macro). Here, the near distance may be 80 cm or less. Since the second lens group LG2 moves along the optical axis, it moves between the first lens group LG1 and the image sensor 300, making it easy to secure movement space.

The lenses may have a maximum Abbe number of 45 or greater, and a maximum refractive index of 1.60 or greater. A lens with the maximum Abbe number can reduce chromatic dispersion, while a lens with the maximum refractive index can increase the chromatic dispersion of incident light.

Within the lens unit 100, the first lens 101, 111 and 121 having the maximum effective length may be an aspherical lens, and the lens with the minimum effective length may be an aspherical lens. The effective length of each lens may be the maximum length of the effective area where effective light is incident, and is the average of the lengths of the object-side surface and the sensor-side surface. The object-side surface of the first lens 101, 111 and 121 of the embodiments of the invention may have a convex shape on the optical axis, and the object-side surface of the nth lens may have a convex shape. This lens unit 100 increases the amount of incident light and allows the incident light to be refracted to the periphery of the image sensor 300. Furthermore, the sensor-side surface of the nth lens, i.e., the fifth lens 105, 115 and 125, has the largest absolute curvature radius among the lens surfaces, thereby reducing the overall length, TTL.

Each of the lenses may include an effective area and an ineffective area. The effective area may be a region through which light incident on each lens passes. In other words, the effective area may be defined as an effective area where incident light is refracted to realize optical characteristics. The ineffective area may be disposed around the effective area and may be defined as a flange portion. The non-effective area may be an area where effective light is not incident from the plurality of lenses. In other words, the non-effective area may be an area unrelated to the optical characteristics. Furthermore, the end of the non-effective area may be an area fixed to a lens barrel (not shown) that accommodates the lenses.

The effective length of each lens and the effective length of each lens surface may be the minimum effective length in a first direction X orthogonal to the optical axis, and the maximum effective length in a second direction Y. The first and second directions X and Y are mutually orthogonal. In the following description, the effective length may be the straight-line length between the two ends of the effective area passing through the optical axis, or the effective diameter or diameter of an imaginary circle passing through the edge of the effective area. Furthermore, if the lens surface is circular, the length of the effective area may be defined as the effective length, effective diameter, or diameter. If the lens surface is non-circular, the length of the effective area may be defined as the effective length, and depending on the direction, may be defined as the maximum effective length or major axis length, and the minimum effective length or minor axis length.

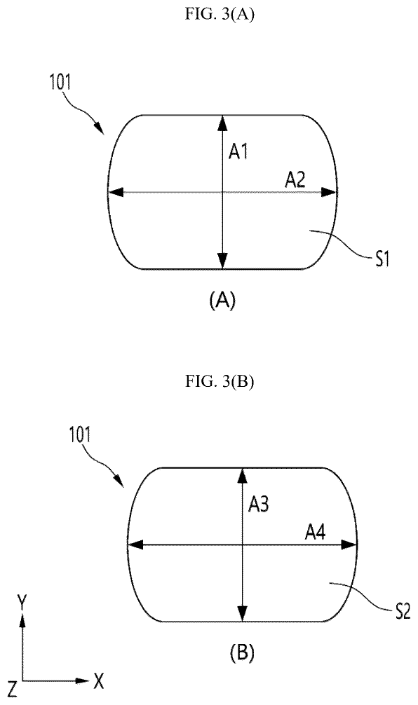

At least one lens within the lens unit 100 may have a non-circular shape. The lens(es) within the lens unit 100 having a larger effective diameter than the object-side lens disposed on an object side of the aperture stop may have a non-circular shape. As another example, the lens(es) within the lens unit 100 having a larger effective diameter than the sensor-side lens disposed on a sensor side of the aperture stop may have a non-circular shape. For example, the first lens 101, 111 and 121 may have a non-circular shape. When the first lens 101, 111 and 121 has a non-circular shape, the effective length in the first direction X and the effective length in the second direction Y may differ, as illustrated in FIG. 3. For example, the object-side first surface S1 of the first lens 101, 111 and 121 may have an effective length A1 in the second direction Y passing through the center that is shorter than the effective length A2 in the first direction X passing through the center. The second surface S2 of the first lens 101, 111 and 121 may have an effective length A3 in the second direction Y passing through the center that is shorter than the effective length A4 in the first direction X. Here, the effective lengths A2 and A4 in the first direction are the maximum lengths in the first and second surfaces S1 and S2, and the effective lengths A1 and A3 in the second direction are the minimum lengths in the first and second surfaces S1. When the first lens 101, 111 and 121 having the largest effective length within the lens unit 100 is provided in a non-circular shape, the thickness of the camera module 1000 in the second direction Y may be reduced, and this thickness reduction can reduce the thickness of a portable electronic device having the camera module.

Within the camera module 1000, the TTL may be three times greater than ImgH, for example, 3<TTL/ImgH<8. Preferably, the condition may satisfy: 3<TTL/ImgH<6. The ImgH is the length from the center of the image sensor 300 to the diagonal end, or half the diagonal length of the image sensor 300. Within the camera module 1000, the effective focal length (EFL) may be greater than 7 mm and the diagonal field of view (FOV) may be less than 40 degrees, for example, 30 degrees or less, so as to be provided as a tele-optical system. That is, for the tele-optical system, the focal length may be greater than 7 mm and the FOV may be provided as 30 degrees or less, so as to be provided as a folded optical system. In addition, the second lens group LG2 may be focused from infinity to a near distance, so as to provide a macro-type folded optical system.

The length of the image sensor 300 is the maximum length in the diagonal direction orthogonal to the optical axis OA. The number of lenses within the camera module 1000 having an effective length greater than the diagonal length of the image sensor 300 may be one or less, for example, less than one. Preferably, ImgH, which is half the diagonal length of the image sensor 300, may be less than the maximum effective length of each lens. Furthermore, the maximum effective length of the first lens 101, 111 and 121 closest to the object is the average of the maximum effective lengths of the object-side and sensor-side surfaces, and may be 1.1 times or more greater than ImgH.

The aperture stop ST may control the amount of light incident on the camera module 1000. The aperture stop ST may be disposed between any two lenses within the lens unit 100. The lenses adjacent to the object side and the sensor side of the aperture stop ST may have effective lengths that are smaller than the effective length of the first lens 101, 111 and 121. The effective length of the lens located on the object side of the aperture stop ST may be greater than the effective length of the lens located on the sensor side of the aperture stop ST. The effective length of the lens adjacent to the sensor side of the aperture stop ST may have a minimum effective diameter within the lens unit 100. In this way, the aperture stop ST can provide a slim optical system by adjusting the effective lengths of two adjacent lenses. The center thickness of the n−1th lens may be thinner than the center thickness of the n-th lens, thereby reducing the TTL. In addition, the center thickness of the first lens 101, 111 and 121 of the optical system may be thicker than the center thickness of the last lens, and the Sag (Sagittal height) values of the object-side and sensor-side surfaces of the first lens 101, 111 and 121 may be greater than the Sag values of the object-side and sensor-side surfaces of the last lens. Accordingly, the first lens 101, 111 and 121 may increase the amount of incident light, compensate for the degradation of optical characteristics due to resolution within the optical system, improve chromatic aberration control characteristics, and improve the vignetting characteristics of the camera module 1000. Here, the Sag value is the distance from the center of the object-side or sensor-side surface of each lens to the lens surface in the direction of the optical axis, from a straight line perpendicular to the optical axis.

For the lens surfaces disposed between the object and the aperture stop ST, the effective length of the lens surfaces tends to decrease from the object side toward the aperture stop ST. Among the lens surfaces disposed between the aperture stop ST and the image sensor 300, the effective length of the lens surfaces tends to increase from the aperture stop ST toward the sensor.

The aperture stop ST may be disposed around the object-side surface with the minimum effective length within the first lens group LG1 or around the object-side surface with the minimum effective length within the second lens group LG2. Alternatively, at least one lens selected from the plurality of lenses may function as an aperture stop. Specifically, the object-side surface or the sensor-side surface of one lens selected from the lenses of the camera module 1000 may function as an aperture stop that controls the amount of light.

The optical axis distance CG3 between the first lens group LG1 and the second lens group LG2 may be the optical axis distance between the sensor-side surface of the first lens group LG1 and the object-side surface of the second lens group LG2. The optical axis distance CG3 between the first lens group LG1 and the second lens group LG2 may be greater than the optical axis distances between adjacent lenses. That is, the optical axis distance CG3 between the first lens group LG1 and the second lens group LG2 may be the largest among the optical axis distances between adjacent lenses. The optical axis distance CG3 between the first lens group LG1 and the second lens group LG2 may be variable when the second lens group LG2 moves in the optical axis direction. The optical axis distance BFL between the second lens group LG2 and the image sensor 300 may be variable when the second lens group LG2 moves in the optical axis direction. The variable optical axis distance CG3′ and BFL1 may satisfy at least one of the following conditions.

0.5 mm<CG3′<5 mm Condition 1:

3.3 mm<BFL1<7.8 mm Condition 2:

Preferably, Condition 1 may fall within the range of 1.75 mm<CG3′<5 mm. Furthermore, Condition 2 may fall within the range of 3.75 mm<BFL1<7 mm. The FOV of the camera module 1000 is less than 40 degrees, and the change in the FOV due to the movement of the second lens group LG2 may be less than 10 degrees, for example, less than 5 degrees or less than 3 degrees. That is, when focusing from infinity to a near distance, the change in the FOV gradually decreases, and the change in the FOV may be set to be small to limit the amount of movement. Here, the first lens group LG1 may include a first lens 101, 111 and 121, a second lens 102, 112 and 122, and a third lens 103, 113 and 123, and the second lens group LG2 may include a fourth lens 104, 114 and 124 and a fifth lens 105, 115 and 125.

The optical axis distance CG3 between the first lens group LG1 and the second lens group LG2 may be smaller than the optical axis distance TLG1 of the first lens group LG1 and larger than the optical axis distance TLG2 of the second lens group LG2. The optical axis distance TLG1 of the first lens group LG1 is the optical axis distance from the object-side surface of the first lens 101, 111 and 121 to the sensor-side surface of the third lens 103, 113 and 123. The optical axis distance TLG2 of the second lens group LG2 is the optical axis distance between the object-side surface of the fourth lens 104, 114 and 124 and the sensor-side surface of the fifth lens 105, 115 and 125.

The sensor-side surface of the first lens group LG1 may have a concave shape on the optical axis, and the object-side surface of the second lens group LG2 may have a concave shape on the optical axis. Here, in each of the first and second lens groups LG1 and LG2, the object-side surface may be the object-side surface of the lens closest to the object in each lens group, and the sensor-side surface may be the sensor-side surface of the lens closest to the image sensor 300 in each lens group. The two lens surfaces of the first and second lens groups LG1 and LG2 facing each other may have a concave shape.

The first lens group LG1 may have positive (+) power, and the second lens group LG2 may have negative (−) power. The first lens 101, 111 and 121 may have positive (+) power, and the fifth lens 105, 115 and 125, which is closest to the sensor among the lenses of the second lens group LG2, may have positive (+) power. When the focal length of the first lens group LG1 is F13 or FLG1, and the focal length of the second lens group LG2 is F45 or FLG2, the following conditions may be satisfied.

FLG1<|FLG2| Condition 1:

−130 mm<FLG2<−10 mm Condition 2:

Preferably, the range may be −80 mm<FLG2<−15 mm. The focal length of the second lens group LG2 may be restricted to limit the amount of movement of the second lens group LG2.

Since the second lens group LG2 moves in the optical axis direction within the lens unit 100, the optical axis distance between the object-side surface S1 of the first lens 101, 111 and 121 and the reflective member 510 may be reduced, for example, to 1.2 mm or less, for example, to a range of 0.1 mm to 1.2 mm.

Within the camera module 1000, the composite focal length of the first lens 101, 111 and 121 and the second lens 102, 112 and 122 may be F12 and may have positive power. The composite focal length from the first lens 101, 111 and 121 to the fourth lens 104, 114 and 124 may be F14 and may have positive power. The composite focal length from the first lens 101, 111 and 121 to the fifth lens 105, 115 and 125 may be F15 or F, which is the overall focal length (EFL), and may have positive power.

The composite focal length from the second lens 102, 112 and 122 to the third lens 103, 113 and 123 may be F23 and may have negative power. The composite focal length from the second lens 102, 112 and 122 to the fourth lens 104, 114 and 124 is F24 and may have negative power. The composite focal length from the second lens 102, 112 and 122 to the fifth lens 105, 115 and 125 is F25 and may have negative power. The composite focal length from the third lens 103, 113 and 123 to the fourth lens 104, 114 and 124 is F34 and may have negative power. The composite focal length from the third lens 103, 113 and 123 to the fifth lens 105, 115 and 125 is F35 and may have negative power.

The number of lenses with negative (−) power within the camera module 1000 may be smaller than the number of lenses with positive (+) power. The number of lenses with negative (−) power may be less than 50% of the total number of lenses.

The first lens group LG1 may refract light incident through the object side in the direction of the optical axis, and the second lens group LG2 may refract light emitted through the first lens group LG1 to the periphery of the image sensor 300. The optical axis distance CG3 between the first lens group LG1 and the second lens group LG2 may be larger than the maximum center thickness CT1 of the lenses within the lens unit 100. The movement distance M1 of the second lens group LG2 for varying the focusing position may be 0.1 mm or more, for example, 0.1 mm<M1<3 mm, when photographing from infinity to a near distance (800 mm or less). Furthermore, the movement distance may be less than 0.9 mm, for example, 0.1 mm<M1<0.9 mm, when photographing from infinity to a near distance of 800 mm. Thus, by limiting the movement of the second lens group LG2 within the camera module to 2.5 mm or less, an increase in the optical axis length of the camera module may be prevented.

Here, the TTL may satisfy the following conditions:

7 mm<TTL<26 mm Condition:

Preferably, the TTL may be 10 mm<TTL<20 mm. Thus, by limiting the TTL value, an increase in the optical axis length of the camera module may be suppressed.

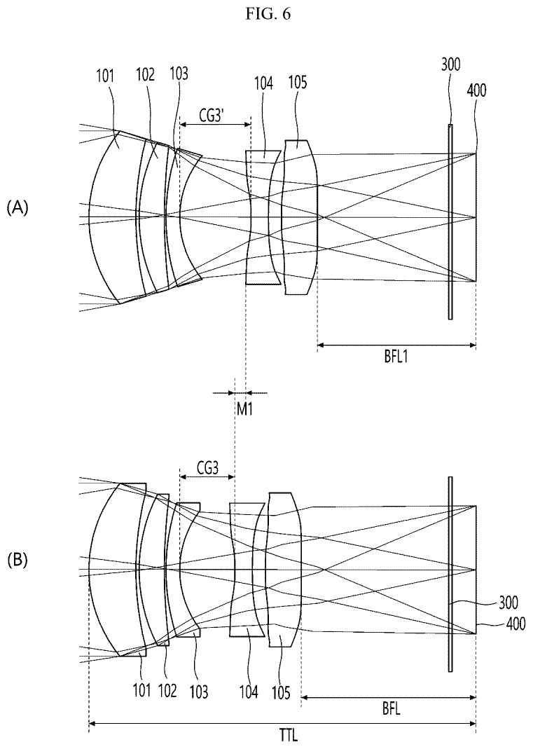

As shown in FIG. 6, when photographing from infinity to a near distance, the optical axis distance CG3 between the third and fourth lenses according to the movement of the second lens group LG2, and the optical axis distance (BLF) between the fifth lens 105, 115 and 125 and the image sensor 300 may satisfy the following conditions. When photographing at infinity, the optical axis distance is CG3 and BFL, and the optical axis distance when photographing at a distance smaller than infinity may be defined as CG3′ and BFL1, and when photographing at the closest distance, the maximum CG3′ may be Max_CG3′, and the minimum BFL1 may be Min_BFL1. This optical axis distance may satisfy at least one of the following conditions.

BFL1<BFL Condition 1:

CG3<CG3′ Condition 2:

1<BFL/CG3<4 Condition 3:

0.5<Min_BFL1/Max_CG3′<1.5 Condition 4:

Here, the maximum CG3′ and minimum BFL1 are the values captured at the closest distance of 150 mm or less. For example, when photographing at 800 mm, the following condition may be satisfied:

1.5<BFL1/CG3′(800)<3 Condition 4:

The sum of the refractive indices of the lenses in the lens unit 100 of the embodiment may be 10 or less, for example, in the range of 6 to 10, and the average refractive indices may be in the range of 1.50 to 1.68. The sum of the Abbe numbers of each lens may be 220 or less, for example, in the range of 150 to 220, and the average Abbe number may be 50 or less, for example, in the range of 30 to 50. The sum of the center thicknesses of the entire lens may be 6 mm or less, for example, in the range of 3 mm to 6 mm or 4 mm to 6 mm. The average of the center thicknesses of the entire lens may be 1.3 mm or less, for example, in the range of 0.7 mm to 1.3 mm.

The sum of the center distances between the lenses along the optical axis OA may be 3.8 mm or less, for example, in the range of 2 mm to 3.8 mm or 2.5 mm to 3.8 mm, and may be less than the sum of the center thicknesses of the lenses. Furthermore, the average effective length of each lens surface of the lens unit 100 may be 3.5 mm or greater, for example, in the range of 3.5 mm to 6 mm. The difference in the effective lengths of adjacent two lenses may be 2 mm or less. The difference between the maximum and minimum effective lengths of the lenses may be 2 mm or less. Therefore, an optical system may be provided in which the effective length difference between adjacent lenses is not significant, and the assembly of lenses assembled within the lens barrel may be improved. Here, among the center distances of the adjacent lenses, the optical axis distance CG3 between the third and fourth lenses and the BFL may be values set during initial or infinity shooting.

The F number (Fno) of the optical system or camera module according to an embodiment of the invention may be 2.0 or greater, for example, in the range of 2.0 to 3.5, or greater than 2.4 and less than 3.0. The maximum FOV (diagonal FOV) of the optical system according to an embodiment of the invention may be less than 40 degrees, for example, greater than 8 degrees and less than 30 degrees, or greater than 17 degrees and less than 27 degrees, thereby providing a telephoto optical system or a macro-optical system capable of continuous zoom. When the total focal length of the camera module 1000 is defined as the 35 mm equivalent focal length F (35 mm) the value may be greater than 70 mm, for example, in the range of 70 mm<F (35 mm)<180 mm. Preferably, the range may be 80 mm<F (35 mm)<160 mm. Thus, the zoom ratio may be constrained by converting it to a 35 mm effective focal length, and the zoom ratio may be 8× or less, for example, 3× to 8×.

The image sensor 300 can detect light and convert it into an electrical signal. The image sensor 300 can detect light passing through the lenses of the lens unit 100. The optical filter 400 may be disposed between the second lens group LG2 and the image sensor 300. For example, the optical filter 400 may be disposed between the last lens and the image sensor 300. The optical filter 400 may include an infrared filter or an infrared cut-off filter (IR cut-off). The optical filter 400 can transmit visible light and reflect infrared light.

The camera module 1000 may be applied to a folded camera that can reduce the thickness of the module. An optical system including a plurality of lenses may have a thinner thickness within the device, and a portable electronic device including the optical system and the camera module may have a thinner thickness.

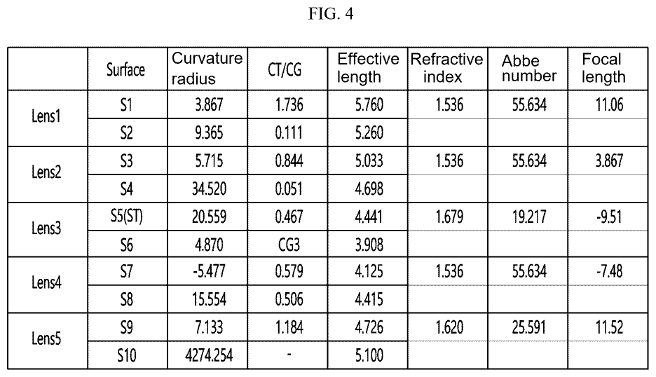

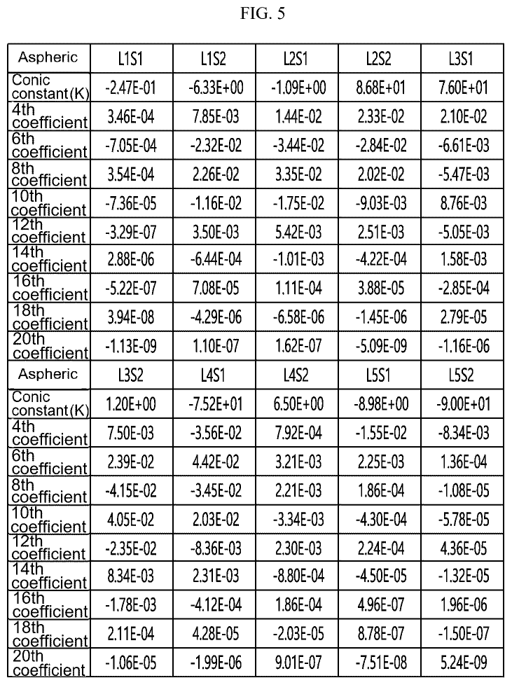

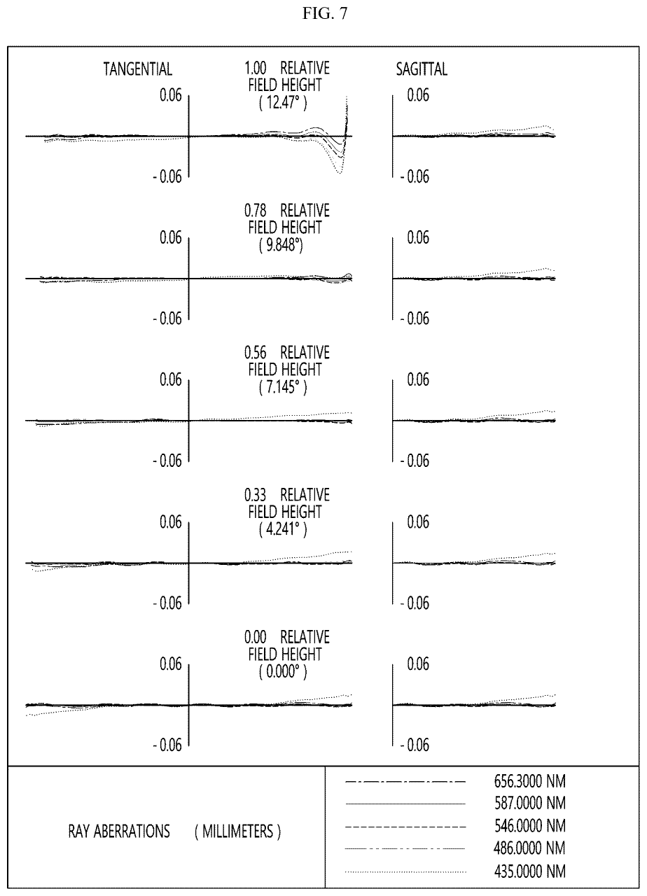

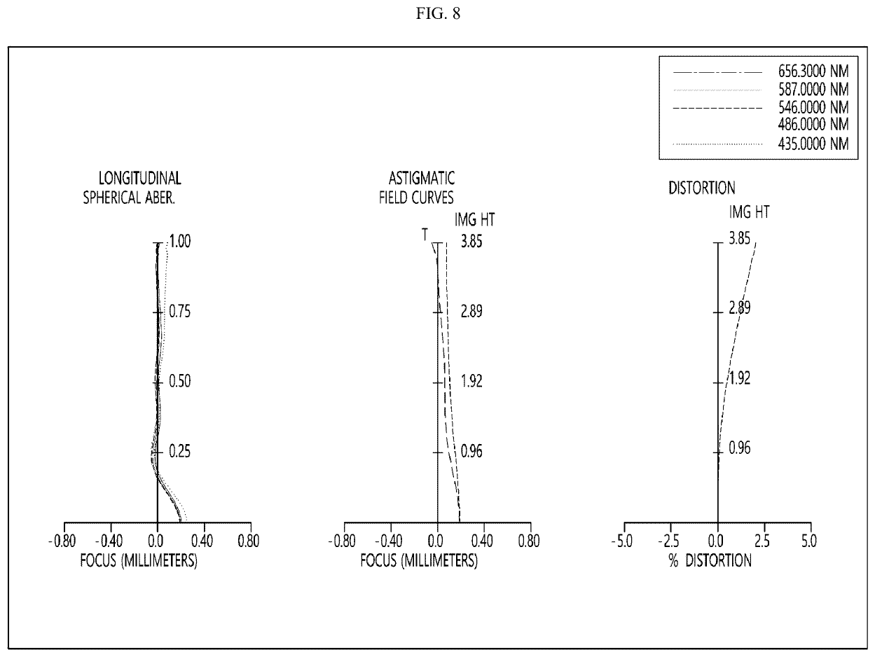

FIG. 2 is a cross-sectional side view of a camera module having a lens section of the optical system of FIG. 1, FIG. 3 is an example of a plan view of the object-side surface and the sensor-side surface of the first lens in the optical system of FIG. 2, FIG. 4 is a table showing the characteristics of the lenses of the optical system of FIG. 2, FIG. 5 is an aspherical coefficient of the object-side surface and the sensor-side surface of the lenses of FIG. 2, FIG. 6 is a diagram comparing the second lens group of the optical system of FIG. 2 before and after movement, FIG. 7 is a graph showing data on ray aberrations of the optical system of FIG. 1, and FIG. 8 is a graph showing data on spherical aberration, astigmatism, and distortion characteristics of the optical system of FIG. 1.

Referring to FIGS. 2 to 8, a camera module 1000 according to the first embodiment may include a first lens 101 to a fifth lens 105. The first through fifth lenses 101, 102, 103, 104, and 105 may be sequentially aligned along the optical axis OA. A reflective member 510 (See FIG. 1) may be disposed on the object side of the first lens 101.

The first through third lenses 101, 102, and 103 are lenses of the first lens group LG1 and are the lenses closest to the object side. The fourth and fifth lenses 104 and 105 may be lenses of the second lens group LG2. The fifth lens 105 is the lens closest to the image sensor 300 within the second lens group LG2 or the lens unit 100. The camera module 1000 may be an optical system with variable focusing position. Specifically, the camera module 1000 may be coupled to a lens barrel having a second driving member 520 (See FIG. 1) around its periphery, and the second driving member 520 may move the second lens group LG2 along the optical axis. By moving the second lens group LG2 in a continuous zoom manner, the camera module can capture images from infinity to a close range of 800 mm or less, with minimal change in the overall focal length. That is, the zoom ratio of the camera module 1000 may be 8× or less.

The first lens 101 may have positive (+) or negative (−) power on the optical axis OA. The first lens 101 may have positive (+) power. The first lens 101 may include a plastic material or glass material, for example, a plastic material. On the optical axis OA, the object-side first surface S1 of the first lens 101 may have a convex shape, and the sensor-side second surface S2 may have a concave shape. The first lens 101 may have a meniscus shape that is convex toward the object side on the optical axis. Alternatively, the first surface S1 may have a concave shape, and the second surface S2 may have a convex shape on the optical axis OA. The first surface S1 and the second surface S2 of the first lens 101 may be aspherical on the optical axis. L1S1 and L1S2 of FIG. 5 show the conic constant K of the first and second surfaces S1 and S2 and the aspherical coefficients from the 4th to the 20th order. Since the first lens 101 is provided as an aspherical lens, deterioration of optical performance may be prevented. That is, even if the thickness of the lens is designed to be thin due to the aspherical material, the distortion of the peripheral part of the lens may be improved. Since the first surface S1 of the first lens 101 has a convex shape and the second surface S2 has a concave shape, the incident light may be refracted in a direction close to the optical axis, and the effective length of the second lens 102 may be set to be smaller than the effective length of the first lens 101. The first lens 101 may be provided with a difference in the curvature radius of the first and second surfaces S1 and S2 of 4 times or less, and an effective length longer than other lenses. In addition, since the first lens 101 is arranged so that the center thickness is thicker than the edge thickness, it may be insensitive to assembly tolerances.

The second lens 102 may be disposed between the first lens 101 and the third lens 103. The second lens 102 may have positive (+) or negative (−) power on the optical axis OA, for example, positive (+) power. The second lens 102 may include a plastic or glass material, and may be provided as a plastic material, for example. The object-side third surface S3 of the second lens 102 on the optical axis OA may be convex, and the sensor-side fourth surface S4 may have a concave shape. The second lens 102 may have a meniscus shape that is convex from the optical axis toward the object side. Alternatively, the third surface S3 may be convex, and the fourth surface S4 may have a convex shape. Alternatively, the second lens 102 may have a concave shape on both sides. The second lens 102 may be provided as an aspherical lens made of plastic. The third surface S3 and the fourth surface S4 may be aspherical. L2S1 and L2S2 of FIG. 5 show the conic constant K and aspherical coefficients from the 4th to the 20th order of the third and fourth surfaces S3 and S4.

The third lens 103 may have positive (+) or negative (−) power on the optical axis OA, for example, negative (−) power. The third lens 103 may include a plastic or glass material, for example, may be made of plastic. The absolute value of the focal length of the third lens 103 may be smaller than the focal length of the first lens 101 and larger than the absolute value of the focal length of the fourth lens 104. Accordingly, the third lens 103 may correct distortion and aberration of incident light. On the optical axis, the fifth surface S5 on the object side of the third lens 103 may have a convex shape, and the sixth surface S6 on the sensor side may have a concave shape. The third lens 103 may have a meniscus shape convex toward the object side on the optical axis. Alternatively, the third lens 103 may have a meniscus shape convex toward the sensor side, or may have a convex or concave shape on both sides of the optical axis. The fifth surface S5 and the sixth surface S6 may be aspherical on the optical axis. L3S1 and L3S2 of FIG. 5 show the conic constant K of the fifth and sixth surfaces S5 and S6 and the aspherical coefficients from the fourth to the twentieth order. The center thickness CT3 of the third lens 103 may be smaller than the center thicknesses CT1 and CT2 of each of the first and second lenses 101 and 102. For example, the center thickness CT3 of the third lens 103 may have the smallest center thickness among the lenses. The effective length of the third lens 103 may be the smallest among the lenses.

The lens shapes of the first lens group LG1, i.e., the first to third lenses 101, 102, and 103, may have a meniscus shape convex toward the object side. The effective lengths of the first to sixth surfaces S1-S6 of the first to third lenses 101, 102, and 103 may gradually decrease from the object side toward the sensor side. For example, the effective lengths of the first to sixth surfaces S1-S6 may gradually decrease from the first surface S1 to the sixth surface S6. Here, the effective length is the maximum length in any direction passing through the center of each lens surface.

The aperture stop ST may be disposed on the perimeter between the second lens 102 and the third lens 103. The aperture stop ST may be disposed on the perimeter of the object-side surface of the third lens 103. Since the aperture stop ST is disposed on the perimeter between the second and third lenses 102 and 103, the difference in effective length between the second and third lenses 102 and 103 may be reduced. The third lens 103 and fourth lens 104 on the sensor side of the aperture stop ST may have the same negative power. The effective lengths of the third and fourth lenses 103 and 104 disposed on the sensor side of the aperture stop ST may be shorter than the effective lengths of the first and second lenses 101 and 102. Here, the effective length of each lens is the average of the effective lengths of the object-side and sensor-side surfaces.

The fourth lens 104 may have positive (+) or negative (−) power on the optical axis OA, for example, negative (−) power. The fourth lens 104 may be made of plastic or glass, for example, plastic. The absolute value of the focal length of the fourth lens 104 may be smaller than the absolute values of the focal lengths of the first, second, and third lenses 101, 102, and 103, so that distortion and aberration may be corrected. In addition, the focal lengths of the fourth lens 104 and the fifth lens 105 may have opposite signs. On the optical axis, the seventh surface S7 on the object side of the fourth lens 104 may be concave, and the eighth surface S8 on the sensor side may have a concave shape. The fourth lens 104 may have a shape in which both sides are concave on the optical axis. At least one or both of the seventh surface S7 and the eighth surface S8 of the fourth lens 104 may be provided as an aspherical surface. L4S1 and L4S2 of FIG. 6 show the conic constant K of the seventh and eighth surfaces S7 and S8 and the aspherical coefficients from the fourth to the twentieth order. Alternatively, the fourth lens 104 may have a meniscus shape convex toward the sensor or a biconvex shape. As another example, the fourth lens 104 may be provided as an aspherical lens made of glass.

The absolute value of the focal length of the fourth lens 104 may be the smallest among the absolute values of the focal lengths of the lenses. At least one, or two or more, of the center thicknesses CT2, CT3, and CT4 of the second, third, and fourth lenses 102, 103, and 104 may have a thickness of 1 mm or less. The effective diameter of the eighth surface S8 of the fourth lens 104 may be the smallest among the effective lengths of the lens surfaces. To correct distortion and aberration caused by the third and fourth lenses 103 and 104, the center distance between the third and fourth lenses 103 and 104 may be set to be greater than the center distance between the first and second lenses 101 and 102, and the focal length of the fourth lens 104 may be set to the smallest negative power. This fourth lens 104 can correct the distortion and aberration of light passing through the first to third lenses 101, 102, and 103 in a direction that eliminates them, and then refracts the light across the entire area of the fifth lens 105.

The fifth lens 105 may have positive (+) or negative (−) power on the optical axis OA, or may have positive (+) power. The fifth lens 105 may be made of plastic or glass, for example, plastic. The ninth surface S9 on the object side of the fifth lens 105 may be convex with respect to the optical axis, and the tenth surface S10 on the sensor side may have a concave shape. The fifth lens 105 may have a shape in which both sides are convex on the optical axis. The fifth lens 105 may be provided as an aspherical lens. At least one or both of the ninth surface S9 and the tenth surface S10 of the fifth lens 105 may be provided as an aspherical surface. L5S1 and L5S2 of FIG. 6 show the conic constant K and aspherical coefficients from the 4th to the 20th order of the ninth and tenth surfaces S9 and S10. Alternatively, the fifth lens 105 may have a meniscus shape convex toward the object side on the optical axis or a concave shape on both sides.

The fifth lens 105 is the n-th lens, has a convex shape on both sides, and may refract incident light toward the center and periphery of the image sensor 300. The difference between the curvature radius of the object-side surface and the curvature radius of the sensor-side surface of each lens may be the largest for the fifth lens 105. For example, the difference in the absolute value of the curvature radius of the object-side surface and the sensor-side surface of the fifth lens 105 may be greater than the difference in the absolute value of the curvature radius of the object-side surface and the sensor-side surface of each of the first to fourth lenses 101, 102, 103, and 104. In addition, the curvature radius of the sensor-side surface of the fifth lens 105 may be provided to be the largest among the radii of curvature of the lens surfaces, thereby reducing the change in light traveling to the image sensor 300 according to the movement of the second lens group LG2. The difference in curvature radius between the ninth and tenth surfaces S9 and S10 of the fifth lens 105 may be significantly increased. For example, the curvature radius of the sensor-side surface of the fifth lens 105 may be at least 5 times, for example, at least 20 times, greater than the curvature radius of the object-side surface.

Within the second lens group LG2, the effective length of the seventh surface S7 may be smaller than the effective length of the tenth surface S10. The effective lengths of the seventh surface S7 to the tenth surface S10 can gradually increase from the seventh surface S7 to the tenth surface S10. Accordingly, light incident on the second lens group LG2 may be refracted to the periphery of the image sensor 300.

At least one or all of the first surface S1 to the tenth surface S10 of the first to fifth lenses 101-105 may be provided without a critical point from the optical axis to the end of the effective area. That is, since the lens surfaces of each lens are provided without a critical point, an image sensor 300 having a smaller size than TTL may be set. The optical axis distance from the center of the sensor-side tenth surface S10 of the fifth lens 105 to the imaging surface of the image sensor 300 is BFL (Back focal length), the optical axis distance from the center of the object-side first surface S1 of the first lens 101 to the object-side tenth surface S10 of the fifth lens 105 is TD, the optical axis distance of the first lens group LG1 is TLG1, the optical axis distance of the second lens group LG2 is TLG2, and SD is the optical axis distance from the aperture stop to the sensor-side surface of the last lens. The camera module 1000 may satisfy at least one of the following conditions:

TLG1<BFL Condition 1:

(TLG1+TLG2)<BFL Condition 2:

SD<BFL Condition 3:

SD<TD Condition 4:

The camera module 1000 provides a long BFL, enabling it to provide a telephoto-type macro-optical system with a focal length F exceeding 7 mm.

As the composite focal lengths of the lenses, F12, F13, F14, F24, F25, F34, and F45 may satisfy the following conditions. The power value of each lens is the reciprocal of the focal length. The optical system may satisfy at least one or two of the following conditions:

F25<F24<0 Condition 1:

F23<F35<0 Condition 2:

F14>F12>0 Condition 3:

F24<F34<0 Condition 4:

F14>0 Condition 5:

F14>F13>0 Condition 6:

F45<0 Condition 7:

F12*4<F14 Condition 8:

|F45|*2>F14 Condition 9:

F13*2<F45 Condition 10:

As shown in FIG. 3, the first lens 101 of the first lens group LG1 may have lengths A1 and A3 in the second direction Y that are shorter than lengths A2 and A4 in the first direction X. Accordingly, the thickness of the camera module 1000 and the height of the mobile terminal in the thickness direction may be reduced. If the maximum effective length of the first surface S1 of the first lens 101 is CA11x and the minimum effective length is CA11y, the condition of the formula may satisfy: 0.55<CA11y/CA11x<0.98. Here, CA11x is the length A2, and CA11y is the length A1. If the value of the formula is less than 0.55, it is difficult to manufacture the object-side surface of the first lens 101 into a non-circular shape and it is difficult to control the distribution of the incident light, and if it is more than 0.98, the size reduction in the second direction of the optical system may be minimal.

If the maximum effective length of the second surface S2 of the first lens 101 is CA12x and the minimum effective length is CA12y, the condition of the formula may satisfy: 0.55<CA12y/CA12x<0.98. Here, CA12x is length A4, and CA12y is length A3. If the value of the above formula is less than 0.55, it is difficult to manufacture the sensor-side surface of the first lens 101 into a non-circular shape, and it is difficult to control the distribution of the incident light. If the value exceeds 0.98, the size reduction in the second direction of the optical system may be minimal. If the lengths of the object-side surface and the sensor-side surface are different in the first and second directions, the first lens 101 may be a D-cut lens. That is, both ends of the first and second surfaces S1 and S2 of the first lens 101 in the first direction may be curved, and both ends in the second direction may be flat cut surfaces. The curved ends of the first and second surfaces S1 and S2 may form a virtual effective diameter, and the cut surfaces at both ends may be parallel to each other.

The maximum effective lengths of the first to tenth surfaces S1-S10 of the first to fifth lenses 101, 102, 103, 104, and 105 in the first direction may be defined as CA11, CA12, CA21, CA22, CA31, CA32, CA41, CA42, CA51, and CA52, and the average of the maximum effective lengths of the object-side surface and the sensor-side surface may be defined as CA1, CA2, CA3, CA4, and CA5. At least one of the following conditions may be satisfied.

CA3<CA2<CA1 Condition 1:

CA3<CA4<CA5 Condition 2:

CA32<CA22<CA12<CA11 Condition 3:

CA32<CA41<CA42<CA51<CA52 Condition 4:

Each of the fourth lens 104 and the fifth lens 105 may have the same effective length in the first and second directions X and Y. For example, the seventh surface S7 of the fourth lens 104 may have the same effective length in the first and second directions X and Y, and the eighth surface S8 may have the same effective length in the first and second directions X and Y. The effective lengths of the ninth surface S9 of the fifth lens 105 in the first and second directions X and Y may be identical, and the effective lengths of the tenth surface S10 in the first and second directions X and Y may be identical. In this way, since the effective lengths of the respective lens surfaces of the fourth and fifth lenses 104 and 105 are arranged identically in the first and second directions, the assembly of the fourth and fifth lenses 104 and 105 within the lens barrel may be prevented from deteriorating.

Also, while the above description described the shape of the first lens 101 as being non-circular, the present invention is not limited thereto, and the effective area of each lens may have a circular shape, and the non-circular shape of each lens may have a non-circular shape. Furthermore, the lens shape of the first lens 101, i.e., the non-circular shape, can also be applied to the second and third embodiments. The lens shapes of the fourth and fifth lenses 104 and 105, i.e., circular shapes, can also be applied to the second and third embodiments.

FIG. 4 is an example of lens data of the optical system of the embodiment of FIG. 2. As shown in FIG. 4, the curvature radius of the optical axis OA of the first to fifth lenses 101, 102, 103, 104, and 105, the center thickness CT of each lens, the center distance CG between adjacent lenses, the refractive index at the d-line, the Abbe number, and the effective length (i.e., the maximum effective length) may be set. The refractive index of the i-th lens is Ndi, the Abbe number of the i-th lens is Vdi, and the value of Ndi*Vdi may be maximum when i is at least one or all of 1, 2, and 4. Additionally, when the value of Ndi*Vdi is 60 or greater, i=1,2,4, and when the value of Ndi*Vdi is less than 60, i=3,5. A lens with a minimum effective diameter within the lens unit 100 may satisfy the condition that the value of Ndi*Vdi is 20<(Ndi*Vdi)<45, where * indicates multiplication.

When expressed as an absolute value, the difference in the radii of curvature between the first and second surfaces S1 and S2 of the first lens 101 may be smaller than the difference in the radii of curvature between the third and fourth surfaces S3 and S4 of the second lens 102. The difference in the radii of curvature between the fifth and sixth surfaces S5 and S6 of the third lens 103 may be larger than the difference in the radii of curvature between the object-side and sensor-side surfaces of the first and fourth lenses 101 and 104. The difference in the curvature radius between the ninth and tenth surfaces S9 and S10 of the fifth lens 105 may be greater than the difference in the curvature radius between the object-side and sensor-side surfaces of the first to fourth lenses 101, 102, 103, and 104, and may be, for example, 50 mm or more. The difference in the curvature radius of the fifth lens 105 may be provided to be large, and for example, the absolute value of the curvature radius of the sensor-side surface of the fifth lens 105 may be set to be at least five times greater than the curvature radius of the object-side surface, thereby lengthening the optical axis distance (BFL) between the last lens 105 and the image sensor 300.

The radii of curvature of the first and second surfaces S1 and S2 of the first lens 101 are defined as L1R1 and L1R2, the radii of curvature of the ninth and tenth surfaces S9 and S10 of the fifth lens 105 are defined as L5R1 and L5R2, and the radii of curvature of each lens surface of the second, third, and fourth lenses 102, 103, and 104 may be defined as L2R1, L2R2, L3R1, L3R2, L4R1, and L4R2. The ratio of the radii of curvature of the object-side surface and the sensor-side surface of each lens may satisfy at least one of the following conditions.

0<L1R1/L1R2<1 Condition 1:

0<L2R1/L2R2<0.5 Condition 2:

1<L3R1/L3R2<7 Condition 3:

0<|L4R1/L4R2|<1 (where L4R1<0) Condition 4:

0<L5R1/L5R2<0.3 Condition 5:

5 mm<L4R2−|L4R1|<20 mm Condition 6:

Preferably, the absolute values of L4R2 and L5R2 may differ by at least 20 mm. Here, the tolerance for the curvature radius may be ±0.05 mm.

When the center thicknesses of the first to fifth lenses 101-105 are defined as CT1-CT5 and the edge thicknesses of the first to fifth lenses 101-105 are defined as ET1-ET5, the sum of the center thicknesses of the first to fifth lenses 101-105 may be defined as ΣCT, and the sum of the edge thicknesses of the first to fifth lenses 101-105 may be defined as ΣET. The ratio of the center thickness and the edge thickness of each lens may satisfy at least one of the following conditions.

1<CT1/ET1<4 Condition 1:

0<CT3/ET3<1 Condition 3:

1<CT5/ET5<4 Condition 5:

1.3<CT2/ET2<4 Condition 2:

0<CT4/ET4<1 Condition 4:

1<ΣCT/ΣET<2 Condition 6:

CT5<CT1 Condition 7:

ET1<ET4 Condition 8:

In the above conditions, if CTi/ETi (i=1~5) is present, the maximum value is 2 when i is 2 and the minimum value is 4 when i is 4. The difference between the center thickness and the edge thickness of each lens may be set to be greater than 0.01 mm and less than 1.5 mm. Furthermore, by designing the center thickness-to-edge thickness ratio of the first and second lenses 101 and 102 to be large, the assembly performance may be prevented from being degraded by the aspherical lens. Furthermore, since the fourth and fifth lenses 104 and 105 are circular and have a large curvature radius on the sensor side, assembly with the lens barrel may be improved.

The center distance between the first to fifth lenses 101-105 is defined as CG1, CG2, CG3, and CG4, and the sum of the center distances between the first to fifth lenses 101-105 may be defined as ΣCG. CT_Max is the maximum center thickness of each lens, and CG_Max is the maximum optical axis distance between two adjacent lenses. The center thickness of each lens and the center distance between adjacent lenses may satisfy at least one of the following conditions:

10<CT1/CG1<25 Condition 1:

10<CT2/CG2<25 Condition 2:

CT3/CG3<1 Condition 3:

0.5<CT4/CG4<1.5 Condition 4:

1<CT5/CG4<4 Condition 5:

CG2<CG1<CG4 Condition 6:

0.5<CG3/ΣCG<1.5 Condition 7:

0<CT_Max/CG_Max<1.5 Condition 8:

Here, if the i-th center distance between two adjacent lenses is defined as CGi, and the center thickness of the i-th lens positioned closer to the object than CGi is defined as CTi, the following conditions may be satisfied. The ratio of CTi/CGi is maximum when i is 2 and minimum when i is 3. The condition that the value of CTi/CGi is maximum when i is 2 may be realized by minimizing the optical axis distance between the second and third lenses 102 and 103, and the shapes of the first to third lenses 101, 102, and 103 may be implemented by a meniscus shape convex toward the object.

When the camera module of FIG. 2 captures images from infinity to close range, the optical axis distance between the third and fourth lenses 103 and 104, the optical axis distance between the fifth lens 105 and the image sensor, and the change in the field of view may be obtained as shown in Table 1.

TABLE 1

| Distances from | | | |
|---|---|---|---|
| the subject (mm) | CG3(CG3′) | BFL(BFL1) | FOV |
| Infinity | 2.343 | 6.378 | 24.934 |
| 2000 | 2.343 | 6.24 | 24.82 |
| 1500 | 2.531 | 6.19 | 24.78 |
| 1000 | 2.628 | 6.09 | 24.70 |
| 800 | 2.701 | 6.02 | 24.64 |
| 600 | 2.825 | 5.90 | 24.55 |
| 400 | 3.079 | 5.64 | 24.36 |
| 200 | 3.867 | 4.85 | 23.83 |
| 150 | 4.528 | 4.19 | 23.37 |

The focal lengths F1, F2, and F5 of the first, second, and fifth lenses 101, 102, and 105 may have positive power, while the focal lengths F3 and F4 of the third and fourth lenses 103 and 104 may have negative power. If the focal lengths of each lens are expressed as absolute values, the difference between the maximum and minimum focal lengths may be 10 mm or less. The aforementioned focal lengths allow the optical system to achieve improved MTF characteristics, aberration control characteristics, and resolution characteristics within the set field of view range, and excellent optical performance in the periphery of the field of view.

FIG. 7 is a graph illustrating the ray aberration characteristics of the optical system of FIG. 2. In the aberration graph of FIG. 7, which is an analysis graph showing transverse aberration in the first and second directions X and Y in the region where the relative field height on the optical axis is 0.0 to 1.0 in the tangential field curvature and sagittal field curvature of the optical system, it may be confirmed that an optical system having a good state of correction of transverse aberration may be obtained for light in wavelength bands of about 435 nm, about 486 nm, about 546 nm, about 587 nm, and about 656 nm. That is, the camera module 1000 according to the embodiment has improved resolution and may have good optical performance not only in the center of the field of view (FOV) but also in the periphery. As confirmed in the above embodiment, the lens system of the embodiment according to the present invention is compact and lightweight with a five-lens configuration, and at the same time, spherical aberration, astigmatism, distortion aberration, chromatic aberration, and coma aberration are all well corrected to enable high resolution implementation, so it may be built into the optical device of a camera and utilized.

FIG. 8 is a graph showing the aberration characteristics of the optical system of FIG. 2. In the aberration graph of FIG. 8, it is a graph measuring spherical aberration (longitudinal spherical aberration), astigmatic field curves, and distortion aberration from left to right. In FIG. 8, the X-axis can represent the focal length (mm) and the degree of distortion (%), and the Y-axis can represent the height of the image. In addition, the graph for spherical aberration is a graph for light in the wavelength bands of about 435 nm, about 486 nm, about 546 nm, about 587 nm, and about 656 nm, and the graph for astigmatism and distortion is a graph for light in the wavelength band of about 546 nm. In these aberration diagrams, the closer each curve is to the Y-axis, the better the aberration correction function may be interpreted. It may be seen that the camera module 1000 according to the embodiment has measured values close to the Y-axis in almost all areas. That is, the camera module 1000 according to the embodiment has improved resolution and may have good optical performance not only in the center of the FOV but also in the periphery.

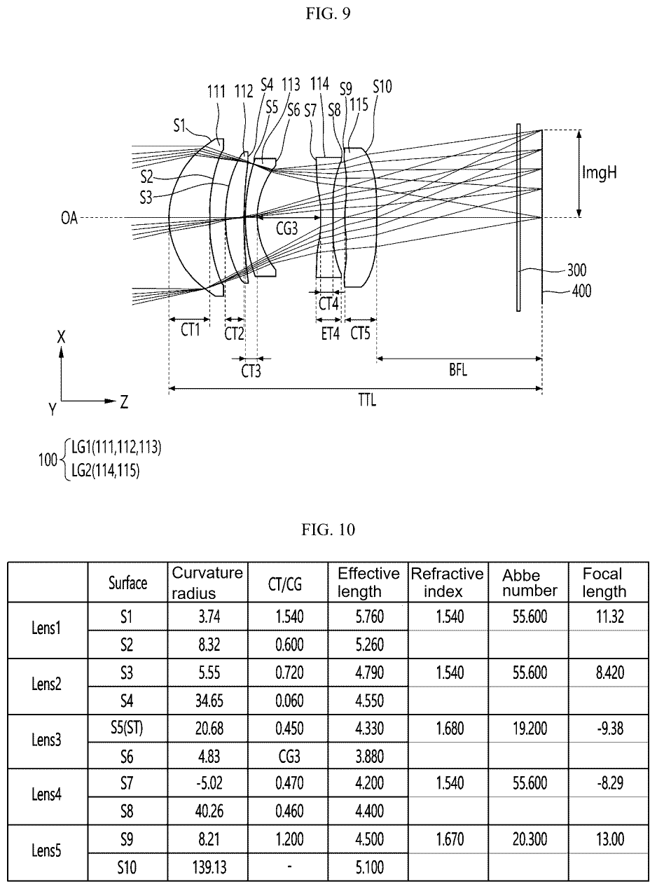

The second embodiment means FIGS. 9 to 13, and the same configuration as the first embodiment means the description of the first embodiment. Referring to FIGS. 9 to 13, a camera module 1000 according to a second embodiment may be a zoom optical system. At least one or all of the first to fifth lenses 111, 112, 113, 114, and 115 may be made of plastic. The object-side surface and the sensor-side surface of each of the first to fifth lenses 111, 112, 113, 114, and 115 may be aspherical on the optical axis. As another example, at least one or all of the first, fourth, and fifth lenses 111, 114, and 115 may be made of glass or a spherical material.

The first lens 111 may have positive (+) power. The object-side first surface S1 of the first lens 111 on the optical axis OA may have a convex shape, and the sensor-side second surface S2 may have a concave shape. The first lens 111 may have a difference in the curvature radius of the first and second surfaces S1 and S2 of 4 times or less, and may be provided with an effective length longer than other lenses. In addition, since the center thickness of the first lens 111 is arranged to be thicker than the edge thickness, the first lens 111 may be insensitive to assembly tolerances. The second lens 112 may have positive (+) power. On the optical axis OA, the object-side third surface S3 of the second lens 112 may have a convex shape, and the sensor-side fourth surface S4 may have a concave shape. Alternatively, the third surface S3 may be convex, and the fourth surface S4 may have a convex shape. Alternatively, the second lens 112 may have a concave shape on both sides. The third lens 113 may have negative (−) power. The absolute value of the focal length of the third lens 113 may be smaller than the focal length of the first lens 111 and larger than the absolute value of the focal length of the fourth lens 114. Accordingly, the third lens 113 can correct distortion and aberration of incident light. On the optical axis, the fifth surface S5 of the third lens 113 on the object side may be convex, and the sixth surface S6 on the sensor side may be concave.

The first to third lenses 111, 112, and 113 may have a meniscus shape convex toward the object side. The effective lengths of the first to sixth surfaces S1-S6 of the first to third lenses 111, 112, and 113 may gradually decrease from the object side toward the sensor side.

The center thickness CT3 of the third lens 113 may be smaller than the center thicknesses CT1 and CT2 of each of the first and second lenses 111 and 112. For example, the center thickness CT3 of the third lens 113 may have the smallest center thickness among the lenses.

The aperture stop ST may be disposed on the periphery between the second lens 112 and the third lens 113. The aperture stop ST may be disposed on the periphery of the object-side surface of the third lens 113. Since the aperture stop ST is disposed on the periphery between the second and third lenses 112 and 113, the difference in effective length between the third and fourth lenses 113 and 114 may be reduced. The sensor-side third lens 113 and the fourth lens 114 of the aperture stop ST may have the same negative power. The effective lengths of the third and fourth lenses 113 and 114 disposed on the sensor side of the aperture stop ST may be shorter than those of the first and second lenses 111 and 112.

The fourth lens 114 may have negative power on the optical axis OA. The absolute value of the focal length of the fourth lens 114 may be smaller than the absolute values of the focal lengths of the first, second, and third lenses 111, 112, and 113, thereby correcting distortion and aberration. Furthermore, the focal lengths of the fourth lens 114 and the fifth lens 115 may have opposite signs. The seventh surface S7 on the object side of the fourth lens 114 on the optical axis may be concave, and the eighth surface S8 on the sensor side may have a concave shape. The fourth lens 114 may have the shortest effective length among the lenses. The absolute value of the focal length of the fourth lens 114 may be the smallest among the absolute values of the focal lengths of the lenses. The effective diameter of the eighth surface S8 of the fourth lens 114 may be the smallest among the effective lengths of the lens surfaces.

The difference between the absolute values of the radii of curvature of the object-side surface and the sensor-side surface of each of the lenses 111-115 may be the largest for the fifth lens 115. For example, the difference between the absolute values of the radii of curvature of the object-side surface and the sensor-side surface of the fifth lens 115 may be greater than the difference between the absolute values of the radii of curvature of the object-side surface and the sensor-side surface of each of the first to fourth lenses 111, 112, 113, and 114.

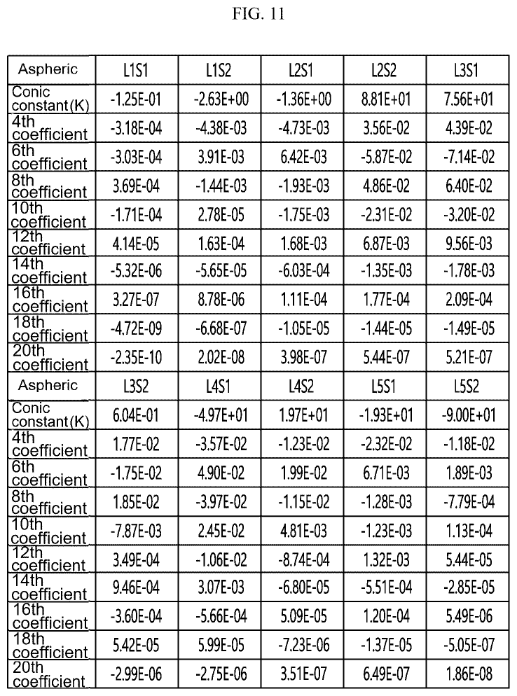

The fifth lens 115 may have positive (+) power on the optical axis OA. On the optical axis, the object-side ninth surface S9 of the fifth lens 115 may have a convex shape, and the sensor-side tenth surface S10 may have a concave shape. As shown in FIG. 11, the first to tenth surfaces S1 to S10 of the first to fifth lenses 111-115 may be aspherical, and L1S1 to L5S2 indicate the conic constant K of the first to tenth surfaces S1 to S10 and aspherical coefficients from the fourth to the twentieth order. At least one or both of the first surface S1 to the eighth surface S8 of the first to fourth lenses 111-114 may be provided without a critical point from the optical axis to the end of the effective area.

At least one or both of the ninth surface S9 and the tenth surface S10 of the fifth lens 115 may have a critical point from the optical axis to the end of the effective area. For example, the critical point position of the ninth surface S9 may be positioned closer to the edge than the critical point position of the tenth surface S10 relative to the optical axis. Accordingly, since the critical point of the tenth surface S10 is located in the central region of the tenth surface S10, light refraction at the edge of the image sensor 300 may be controlled and the problem of refracted light escaping the end of the image sensor 300 due to the distance of the BFL may be prevented. The camera module 1000 may satisfy at least one of the following conditions:

TLG1<BFL Condition 1:

SD<BFL Condition 3:

(TLG1+TLG2)<BFL Condition 2:

SD<TD Condition 4:

The camera module 1000 may provide a telescopic optical system with a focal length F exceeding 7 mm by providing a BFL.

The optical system may satisfy at least one or two of the following conditions:

F23,F24,F25,F34,F45<0 Condition 1:

F12,F13,F14>0 Condition 2:

F12*3<F14 Condition 3:

F14>|F45| Condition 9:

F13*2<|F45| Condition 10:

The effective diameters of each lens must satisfy at least one of the following conditions:

CA3<CA2<CA1 Condition 1:

CA3<CA4<CA5 Condition 2:

CA32<CA22<CA12<CA11 Condition 3:

CA32<CA41<CA42<CA51<CA52 Condition 4:

FIG. 10 is an example of lens data of the optical system of the second embodiment of FIG. 9. As shown in FIG. 10, the curvature radius of the optical axis OA of the first to fifth lenses 111-115, the center thickness CT of each lens, the center distance CG between adjacent lenses, the refractive index at the d-line, the Abbe number, and the effective length (i.e., the maximum effective length) may be set. The refractive index of the i-th lens is Ndi, the Abbe number of the i-th lens is Vdi, and the value of Ndi*Vdi may be maximum when i is at least one or all of 1, 2, and 4. In addition, when the value of Ndi*Vdi is 60 or more, i=1,2,4, and when the value of Ndi*Vdi is less than 60, i=3,5. Within the lens unit 100, a lens having a minimum effective diameter may satisfy the condition that the value of Ndi*Vdi is 20<(Ndi*Vdi)<45, where * indicates multiplication.

When expressed as an absolute value, the difference in the radii of curvature between the first and second surfaces S1 and S2 of the first lens 111 may be greater than the difference in the radii of curvature between the third and fourth surfaces S3 and S4 of the second lens 112. The difference in the radii of curvature (absolute value) between the seventh and eighth surfaces S7 and S8 of the fourth lens 114 may be greater than the difference in the radii of curvature between the first surface S1 and the second surface S2 of the first lens 111. The difference in the curvature radius (absolute value) between the ninth and tenth surfaces S9 and S10 of the fifth lens 115 may be greater than the difference in the curvature radius (absolute value) between the object-side and sensor-side surfaces of the first to fourth lenses. The difference in the curvature radius between the ninth and tenth surfaces S9 and S10 of the fifth lens 115 may be significant. For example, the curvature radius of the sensor-side surface of the fifth lens 105 may be at least five times, for example, at least ten times, greater than the curvature radius of the object-side surface.

The ratio of the curvature radius between the object-side and sensor-side surfaces of each lens may satisfy at least one of the following conditions:

0<L1R1/L1R2<1 Condition 1:

0<L2R1/L2R2<0.5 Condition 2:

2<L3R1/L3R2<7 Condition 3:

0<|L4R1/L4R2|<0.5 (where L4R1<0) Condition 4:

0<L5R1/L5R2<0.3 Condition 5:

5 mm<L4R2−|L4R1|<40 mm Condition 6:

Preferably, the values of L4R2 and L5R2 can differ by at least 20 mm.

The ratio of the center thickness to the edge thickness of each lens may satisfy the following conditions:

1<CT1/ET1<4 Condition 1:

0<CT3/ET3<1 Condition 3:

1<CT2/ET2<4 Condition 2:

0<CT4/ET4<1 Condition 4:

1<CT5/ET5<4 Condition 5:

1<ΣCT/ΣCT<2 Condition 6:

CT1/ΣCT<0.45 Condition 7:

CT4/ΣCT<0.3 Condition 7:

In the above conditions, for CTi/ETi (i=1~5), the maximum is when i is 1 or 2 and the minimum is when i is 3 or 4. The difference between the center thickness and the edge thickness of each lens may be set to be greater than 0.01 mm and less than 1.2 mm. Furthermore, by designing the center thickness to edge thickness ratio of the first and second lenses 111 and 112 to be as large as possible, assembly performance degradation due to aspherical lenses may be prevented. Furthermore, the fourth and fifth lenses 114 and 115 have a large curvature radius on the sensor-side and are circular in shape, thereby improving assembly performance with the lens barrel.

The center thickness of each lens and the center distance between adjacent lenses may satisfy at least one of the following conditions:

2<CT1/CG1<5 Condition 1:

5<CT2/CG2<15 Condition 2:

CT3/CG3<1 Condition 3:

0.5<CT4/CG4<1.5 Condition 4:

1<CT5/CG4<5 Condition 5:

CG2<CG4<CG1 Condition 6:

0.3<CG3/ΣCG<1.5 Condition 7:

0.3<CT_Max/CG_Max<1.5 Condition 8:

Here, the ratio CTi/CGi is maximum when i is 2 and minimum when i is 3. The condition that the above CTi/CGi value is maximum when i is 2 may be realized by minimizing the optical axis distance between the second and third lenses 112 and 113 and by forming the first to third lenses 111, 112, and 113 into a meniscus shape convex toward the object.

When the camera module of FIG. 9 is used to capture images from infinity to close range, the optical axis distance between the third and fourth lenses 113 and 114, the optical axis distance between the fifth lens 115 and the image sensor, and the change in the FOV may be obtained as shown in Table 2.

TABLE 2

| Distances from | | | |
|---|---|---|---|
| the subject (mm) | CG3(CG3′) | BFL(BFL1) | FOV |
| Infinity | 2.410 | 6.300 | 24.700 |
| 2000 | 2.569 | 6.14 | 24.61 |
| 1500 | 2.623 | 6.09 | 24.57 |
| 1000 | 2.731 | 5.98 | 24.50 |
| 800 | 2.813 | 5.90 | 24.44 |
| 600 | 2.952 | 5.76 | 24.35 |
| 400 | 3.240 | 5.47 | 24.18 |
| 200 | 4.183 | 4.53 | 23.64 |
| 150 | 4.899 | 3.81 | 23.23 |

The focal lengths F1, F2, and F5 of the first, second, and fifth lenses 111, 112, and 115 may have positive power, while the focal lengths F3 and F4 of the third and fourth lenses 113 and 114 may have negative power. When expressed as absolute values, the focal length of the fifth lens 115 is the largest among the lenses and may be 10 mm or greater. The focal length of the fourth lens 114 is the smallest among the lenses. The difference between the maximum and minimum focal lengths may be 10 mm or less. Due to the focal lengths, the optical system may have improved MTF characteristics, aberration control characteristics, resolution characteristics, etc. within the set field of view range, and may have excellent optical performance in the periphery of the field of view.

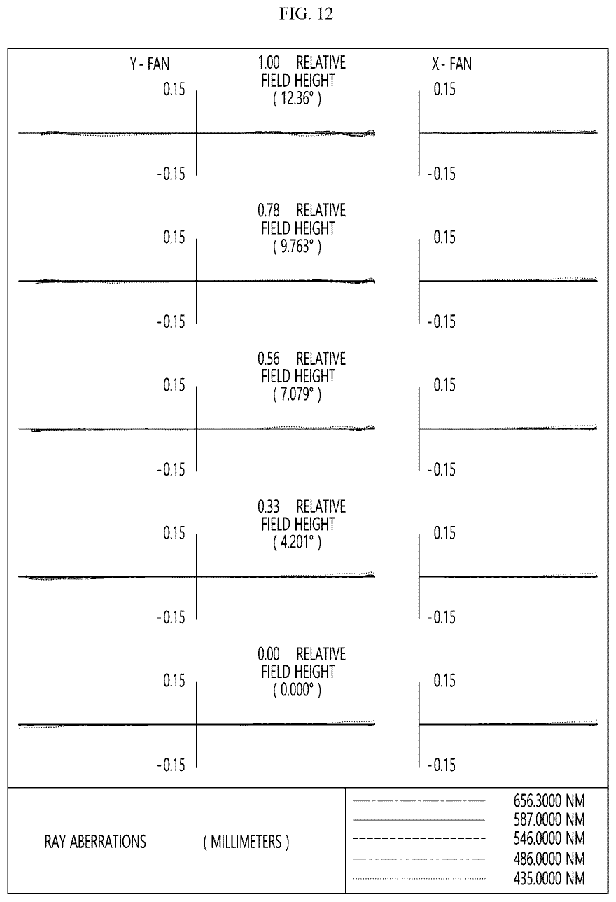

FIG. 12 is a graph illustrating the ray aberration characteristics of the optical system according to the second embodiment. In the aberration graph of FIG. 12, as an analysis graph showing transverse aberration in the first and second directions X and Y in the region where the relative field height on the optical axis is 0.0 to 1.0 in the tangential field curvature and sagittal field curvature of the optical system, it may be confirmed that an optical system having a good state of correction of transverse aberration may be obtained for light in wavelength bands of about 435 nm, about 486 nm, about 546 nm, about 587 nm, and about 656 nm. That is, the camera module 1000 according to the embodiment has improved resolution and may have good optical performance not only in the center of the FOV but also in the periphery. As confirmed in the above embodiment, the lens system of the embodiment according to the present invention is compact and lightweight with a five-lens configuration, and at the same time, spherical aberration, astigmatism, distortion aberration, chromatic aberration, and coma aberration are all well corrected to enable high resolution, so that it may be built into the optical device of a camera and utilized.

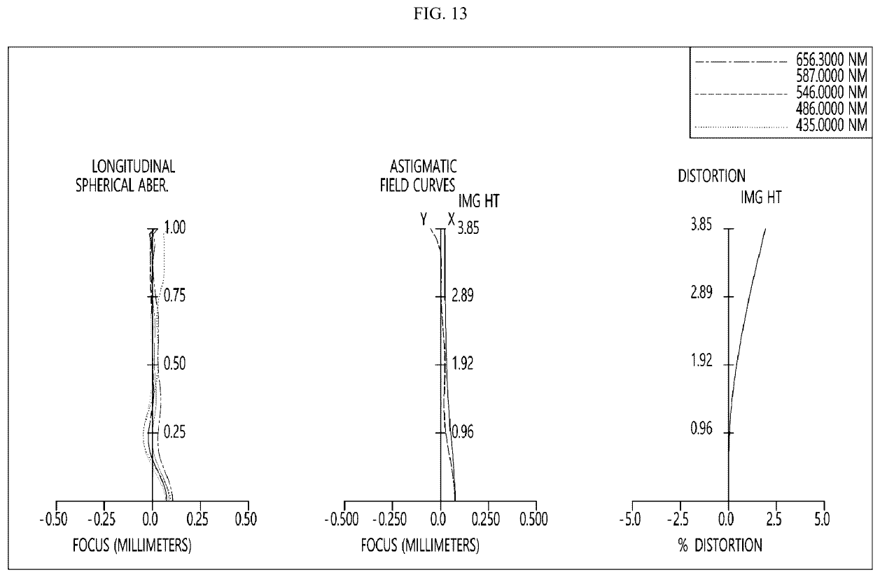

FIG. 13 is a graph showing the aberration characteristics of the optical system of FIG. 9. In the aberration graph of FIG. 13, it is a graph measuring spherical aberration (longitudinal spherical aberration), astigmatic field curves, and distortion aberration from left to right. In FIG. 13, the X-axis can represent the focal length (mm) and the degree of distortion (%), and the Y-axis can represent the height of the image. Additionally, the graphs for spherical aberration are for light in wavelength bands of approximately 435 nm, 486 nm, 546 nm, 587 nm, and 656 nm, while the graphs for astigmatism and distortion are for light in wavelength bands of approximately 546 nm. In these aberration diagrams, the closer each curve is to the Y-axis, the better the aberration correction function. The camera module 1000 according to the embodiment shows that the measured values are close to the Y-axis in almost all areas. In other words, the camera module 1000 according to the embodiment has improved resolution and can exhibit excellent optical performance not only in the center but also in the periphery of the FOV.

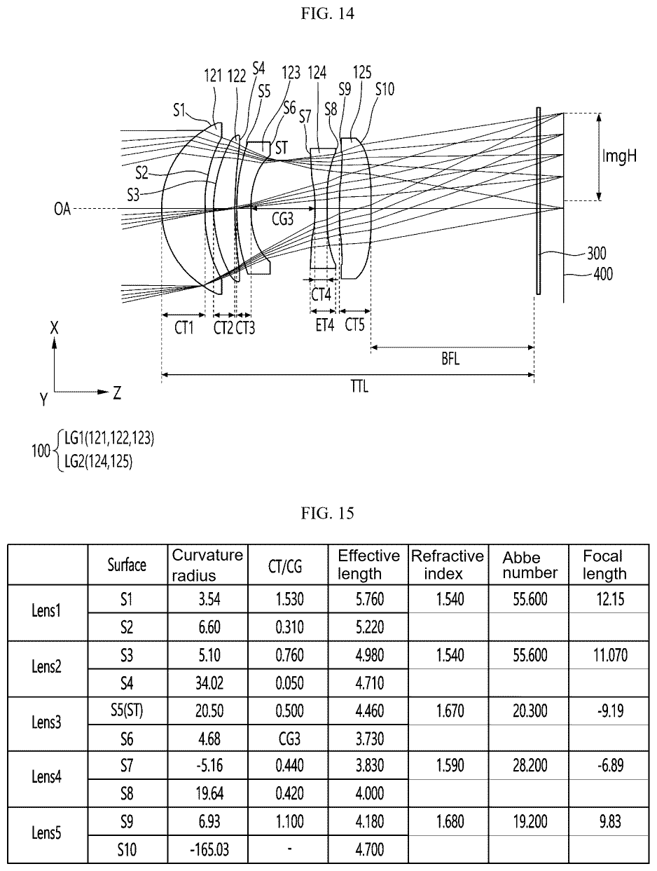

The third embodiment is described with reference to FIGS. 14 to 18, and the description of the first embodiment will be referred to for configurations identical to those of the first embodiment. Referring to FIGS. 14 to 18, a camera module 1000 according to a third embodiment may be a zoom optical system. At least one or all of the first to fifth lenses 121, 122, 123, 124, and 125 may be made of a plastic material. The object-side surface and the sensor-side surface of each of the first to fifth lenses 121, 122, 123, 124, and 125 may be aspherical on the optical axis. As another example, at least one or all of the first, fourth, and fifth lenses 121, 124, and 125 may be made of glass or a spherical material. The first lens 121 may have positive (+) power. On the optical axis OA, the object-side first surface S1 of the first lens 121 may have a convex shape, and the sensor-side second surface S2 may have a concave shape. The second lens 122 may have positive (+) power. On the optical axis OA, the object-side third surface S3 of the second lens 122 may be convex, and the sensor-side fourth surface S4 may have a concave shape. The third lens 123 may have negative (−) power. The absolute value of the focal length of the third lens 123 may be smaller than the focal length of the first lens 121 and larger than the absolute value of the focal length of the fourth lens 124. Accordingly, the third lens 123 may correct distortion and aberration of incident light. On the optical axis, the object-side fifth surface S5 of the third lens 123 may be convex, and the sensor-side sixth surface S6 may have a concave shape.

The fourth lens 124 may have negative (−) power on the optical axis OA. The absolute value of the focal length of the fourth lens 124 may be smaller than the absolute values of the focal lengths of the first, second, and third lenses 121, 122, and 123, thereby correcting distortion and aberration. Furthermore, the focal lengths of the fourth lens 124 and the fifth lens 125 may have opposite signs. The object-side seventh surface S7 of the fourth lens 124 may be concave on the optical axis, and the sensor-side eighth surface S8 may have a concave shape. The fifth lens 125 may have positive (+) power on the optical axis OA. The object-side ninth surface S9 of the fifth lens 125 may be convex on the optical axis, and the sensor-side tenth surface S10 may have a convex shape.

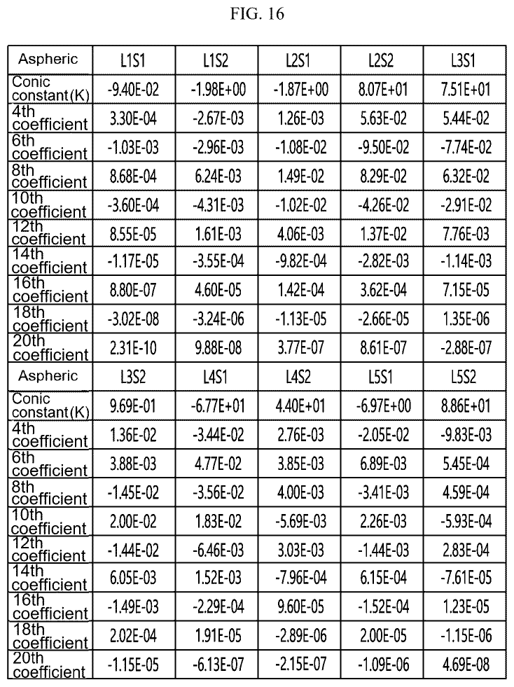

The first to tenth surfaces S1-S10 of the first to fifth lenses 121-125 may be aspherical, and the conic constant K and aspheric coefficients of the fourth to twentieth orders of the surfaces S1-S10 of L1S1 to L5S2 of FIG. 16 are shown. The first to eighth surfaces S1-S8 may be provided without a critical point from the optical axis to the end of the effective area. The ninth surface S9 may have a critical point from the optical axis OA to the end of the effective area, and the tenth surface S10 may be provided without a critical point from the optical axis to the end of the effective area.

The first lens 121 may have a difference in the curvature radius between the first and second surfaces S1 and S2 of no more than four times, and may have a longer effective length than the other lenses. In addition, since the first lens 121 is arranged so that the center thickness is thicker than the edge thickness, it may be insensitive to assembly tolerances. The first to third lenses 121, 122, and 123 may have a meniscus shape that is convex toward the object side. The fourth lens 124 may have a concave shape on both sides, and the fifth lens 125 may have a convex shape on both sides. The effective lengths of the first to sixth surfaces S1-S6 of the first to third lenses 121, 122, and 123 may gradually decrease from the object side toward the sensor side. The effective lengths of the sixth to tenth surfaces S6-S10 may gradually increase from the object side toward the sensor side. The center thickness CT3 of the third lens 123 may be smaller than the center thicknesses CT1 and CT2 of each of the first and second lenses 121 and 122. For example, the center thickness CT3 of the third lens 123 may have the smallest center thickness among the lenses.

The aperture stop ST may be disposed on the perimeter between the third lens 123 and the fourth lens 124. The aperture stop ST may be disposed on the perimeter of the sensor-side surface of the third lens 123. Since the aperture stop ST is disposed on the perimeter between the third and fourth lenses 123 and 124, the difference in effective length between the third and fourth lenses 123 and 124 may be reduced. The third lens 123 and the fourth lens 124 on either side of the aperture stop ST may have the same negative power. The effective lengths of the third and fourth lenses 123 and 124 disposed on the sensor side of the aperture stop ST may be shorter than those of the first and second lenses 121 and 122. The effective length of the fourth lens 124 may be the smallest among the lenses. The absolute value of the focal length of the fourth lens 124 may be the smallest among the absolute values of the focal lengths of the lenses. The effective diameter of the sixth surface S6 of the fourth lens 123 may be the smallest among the effective lengths of the lens surfaces.

When expressed as an absolute value, the difference between the curvature radius (absolute value) of the object-side surface and the curvature radius (absolute value) of the sensor-side surface of each of the lenses 121-125 may be the largest for the fifth lens 125. For example, the difference between the absolute values of the radii of curvature of the object-side surface and the sensor-side surface of the fifth lens 125 may be greater than the difference between the absolute values of the radii of curvature of the object-side surface and the sensor-side surface of each of the first to fourth lenses 121, 122, 123, and 124.

The camera module 1000 may satisfy at least one of the following conditions:

TLG1<BFL Condition 1:

(TLG1+TLG2)<BFL Condition 2:

SD<BFL Condition 3:

SD<TD Condition 4:

The camera module 1000 provides a long BFL, thereby providing a telephoto optical system with a focal length F exceeding 7 mm.

The optical system may satisfy at least one or two of the following conditions:

F23,F24,F25,F34,F45<0 Condition 1:

F12,F13,F14>0 Condition 2:

F12*5<F14 Condition 3:

F14>|F45| Condition 9:

F13*2<|F45| Condition 10:

The effective diameters of each lens may satisfy at least one of the following conditions:

CA3<CA2<CA1 Condition 1:

CA3<CA4<CA5 Condition 2:

CA32<CA22<CA12<CA11 Condition 3:

CA32<CA41<CA42<CA51<CA52 Condition 4:

FIG. 15 is an example of lens data of the optical system of the third embodiment of FIG. 14. As shown in FIG. 15, the curvature radius of the optical axis OA of the first to fifth lenses 121, 122, 123, 124, and 125, the center thickness CT of each lens, the center distance CG between adjacent lenses, the refractive index at the d-line, the Abbe number, and the effective length (i.e., the maximum effective length) may be set. The refractive index of the i-th lens is Ndi, the Abbe number of the i-th lens is Vdi, and the value of Ndi*Vdi may be maximum when i is at least one or both of 1 and 2. In addition, when the value of Ndi*Vdi is 60 or more, i=1, 2, and when the value of Ndi*Vdi is less than 60, i=3, 4, 5. Within the lens unit 100, a lens having a minimum effective diameter may satisfy the condition that the value of Ndi*Vdi is 20<(Ndi*Vdi)<50, where * indicates multiplication.

When expressed as an absolute value, the difference in the radii of curvature between the first and second surfaces S1 and S2 of the first lens 121 may be greater than the difference in the radii of curvature between the third and fourth surfaces S3 and S4 of the second lens 122. The difference in the radii of curvature (absolute value) between the seventh and eighth surfaces S7 and S8 of the fourth lens 124 may be greater than the difference in the radii of curvature between the first surface S1 and the second surface S2 of the first lens 121. The difference in the curvature radius (absolute value) of the ninth and tenth surfaces S9 and S10 of the fifth lens 125 may be greater than the difference in the curvature radius (absolute value) of the object-side surface and the sensor-side surface of the first to fourth lenses 121-124. The difference in the curvature radius of the 9th and 10th surfaces S9 and S10 of the fifth lens 125 may be provided to be large, for example, the curvature radius of the sensor-side surface of the fifth lens 105 may be 5 times or more, for example, 10 times or more, greater than the curvature radius of the object-side surface.

The ratio of the curvature radius of the object-side surface and the sensor-side surface of each lens may satisfy at least one of the following conditions:

0<L1R1/L1R2<1 Condition 1:

0<L2R1/L2R2<0.5 Condition 2:

2<L3R1/L3R2<7 Condition 3:

0<|L4R1/L4R2|<0.7 (where L4R1<0) Condition 4:

0<L5R1/L5R2<0.15 Condition 5:

5 mm<L4R2−|L4R1|<40 mm Condition 6:

Preferably, the absolute values of L4R2 and L5R2 may differ by at least 20 mm.

The ratio of the center thickness to the edge thickness of each lens may satisfy at least one of the following conditions:

1<CT1/ET1<4 Condition 1:

1<CT2/ET2<4 Condition 2:

0<CT3/ET3<1 Condition 3:

0<CT4/ET4<1 Condition 4:

1<CT5/ET5<3 Condition 5:

1<ΣCT/ΣET<2 Condition 6:

CT1/ΣCT<0.45 Condition 7:

CT4/ΣCT<0.3 Condition 7:

In the above conditions, for CTi/ETi (i=1~5), the maximum is when i is 1 or 2 and the minimum is when i is 3 or 4. The difference between the center thickness and the edge thickness of each lens may be set to be greater than 0.01 mm and less than 1.2 mm. Furthermore, by designing the center thickness to edge thickness ratio of the first and second lenses 121 and 122 to be as large as possible, assembly performance degradation due to aspherical lenses may be prevented. Furthermore, the fourth and fifth lenses 124 and 125 are circular with a large curvature radius on the sensor-side, thereby improving assembly performance with the lens barrel.

The center thickness of each lens and the center distance between adjacent lenses may satisfy at least one of the following conditions:

3<CT1/CG1<6 Condition 1:

7<CT2/CG2<25 Condition 2:

CT3/CG3<1 Condition 3:

0.5<CT4/CG4<1.5 Condition 4:

1<CT5/CG4<5 Condition 5:

CG2<CG4<CG1 Condition 6:

0.3<CG3/ΣCG<1.5 Condition 7:

0.3<CT_Max/CG_Max<1.5 Condition 8:

Here, the ratio CTi/CGi is maximum when i is 2 and minimum when i is 3. The condition that the CTi/CGi value is maximum when i is 2 may be realized by minimizing the optical axis distance between the second and third lenses 122 and 123 and by forming the first to third lenses 121, 122, and 123 into a meniscus shape convex toward the object.

When the camera module of FIG. 14 is used to capture images from infinity to close range, the optical axis distance between the third and fourth lenses 123 and 124, the optical axis distance between the fifth lens 125 and the image sensor, and the change in the FOV may be obtained as shown in Table 3.

TABLE 3

| Distances from | | | |
|---|---|---|---|
| the subject (mm) | CG3(CG3′) | BFL(BFL1) | FOV |
| Infinity | 2.260 | 6.830 | 24.900 |
| 2000 | 2.414 | 6.68 | 24.79 |
| 1500 | 2.466 | 6.62 | 24.75 |
| 1000 | 2.573 | 6.52 | 24.67 |
| 800 | 2.653 | 6.44 | 24.61 |
| 600 | 2.790 | 6.30 | 24.51 |
| 400 | 3.073 | 6.02 | 24.32 |
| 200 | 4.000 | 5.09 | 23.79 |
| 150 | 4.702 | 4.39 | 23.43 |

The focal lengths F1, F2, and F5 of the first, second, and fifth lenses 121, 122, and 125 may have positive power, and the focal lengths F3 and F4 of the third and fourth lenses 123 and 124 may have negative power. When the focal lengths are expressed as absolute values, the focal length of the first lens 121 is the largest among the lenses and may be 10 mm or more. The focal length of the fourth lens 124 is the smallest among the lenses. The difference between the maximum focal length and the minimum focal length may be 10 mm or less. Due to the focal lengths, the optical system may have improved MTF characteristics, aberration control characteristics, resolution characteristics, etc. in the set field of view range, and may have good optical performance in the periphery of the field of view.

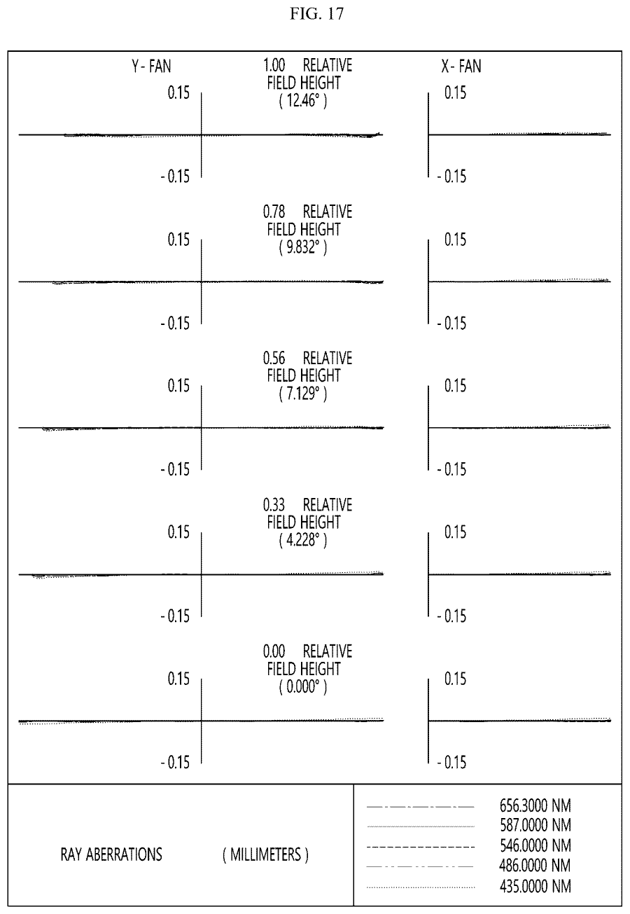

FIG. 17 is a graph of the ray aberration characteristics of the optical system according to the third embodiment. In the aberration graph of FIG. 17, as an analysis graph showing transverse aberration in the first and second directions X and Y in the region where the relative field height on the optical axis is 0.0 to 1.0 in the tangential field curvature and sagittal field curvature of the optical system, it may be confirmed that an optical system having a good state of correction of transverse aberration may be obtained for light in wavelength bands of about 435 nm, about 486 nm, about 546 nm, about 587 nm, and about 656 nm. That is, the camera module 1000 according to the embodiment has improved resolution and may have good optical performance not only in the center of the FOV but also in the periphery. As confirmed in the above embodiment, the lens system of the embodiment according to the present invention is compact and lightweight with a five-lens configuration, and at the same time, spherical aberration, astigmatism, distortion aberration, chromatic aberration, and coma aberration are all well corrected to enable high resolution implementation, so it may be built into the optical device of a camera and utilized.

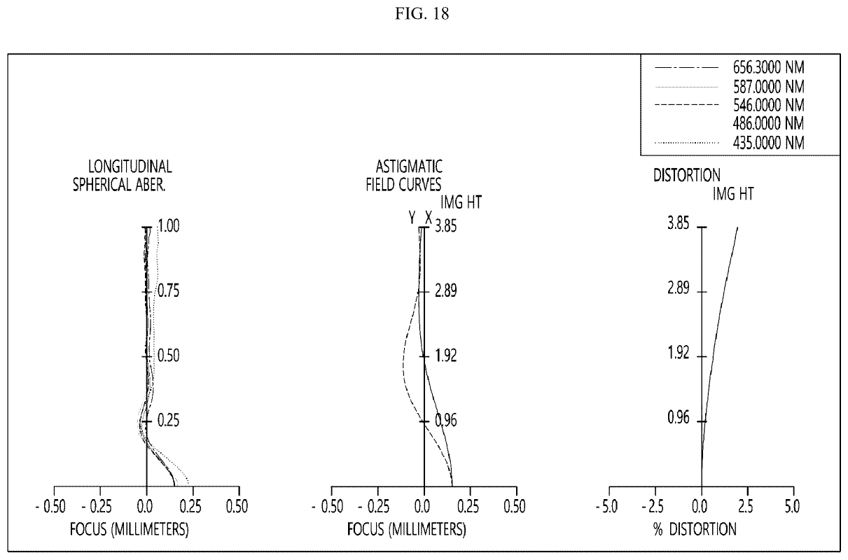

FIG. 18 is a graph showing the aberration characteristics of the optical system of FIG. 14. In the aberration graph of FIG. 18, it is a graph measuring spherical aberration (longitudinal spherical aberration), astigmatic field curves, and distortion from left to right. In FIG. 13, the X-axis can represent the focal length (mm) and the degree of distortion (%), and the Y-axis can represent the height of the image. Additionally, the graphs for spherical aberration are for light in wavelength bands of approximately 435 nm, 486 nm, 546 nm, 587 nm, and 656 nm, while the graphs for astigmatism and distortion are for light in wavelength bands of approximately 546 nm. In these aberration diagrams, the closer each curve is to the Y-axis, the better the aberration correction function. The camera module 1000 according to the embodiment shows that the measured values are close to the Y-axis in almost all areas. In other words, the camera module 1000 according to the embodiment may have improved resolution and superior optical performance not only in the center but also in the periphery of the FOV.

The optical system according to the embodiment of the invention may satisfy at least one of the mathematical expressions described below. Accordingly, if the optical system satisfies at least one of the mathematical expressions below, it may have improved optical characteristics. In addition, when the optical system satisfies at least one of the above mathematical expressions, it may be implemented in a smaller and more compact manner. In addition, when the optical system satisfies at least one of the above mathematical expressions, it may be applied to a folded camera having a thinner thickness, so that a device including the camera may be manufactured with a thin thickness. When the camera module 1000 satisfies at least one mathematical expression, the camera module 1000 can effectively control aberration characteristics such as chromatic aberration and distortion aberration, and may have good optical performance not only in the center but also in the periphery of the FOV. In addition, the camera module 1000 may have improved resolution. In addition, the thickness of the lens on the optical axis OA described in the mathematical expressions and the distance between adjacent lenses on the optical axis OA can refer to the embodiments disclosed above.

L1R1>0 [Mathematical expression 1]

L1R1 is the curvature radius of the object-side surface of the first lens 101, 111 and 121 on the optical axis, and when Mathematical expression 1 is satisfied, the amount of incident light may be increased. Accordingly, the first lens 101, 111 and 121 may have a meniscus shape convex toward the object side. In addition, since the condition may satisfy: L1R1*L1R2>0, the incident light may be refracted in a direction closer to the optical axis. Accordingly, the maximum effective length of the first lens 101, 111 and 121 may be provided to be greater than the maximum effective length of the second lens 102, 112 and 122. The first lens 101, 111 and 121 through the third lens 103, 113 and 123 have a meniscus shape convex toward the object side and can refract incident light toward the area between the first and second lens groups LG1 and LG2.

Furthermore, the conditions may satisfy: L1R1<L1R2 and L2R1<L2R2. Accordingly, the maximum effective lengths of the first and second lenses may be adjusted and the TTL may be reduced. If L2R1>L2R2, the TTL increases.

L4R1*L5R1>0 [Mathematical expression 2]

The sensor-side surface of the fourth lens 104, 114 and 124 may be concave, and the object-side surface of the fifth lens 105, 115 and 125 may have a convex shape. Accordingly, the distance between the fourth and fifth lenses may be reduced, and an increase in the effective diameter of the fifth lens 105, 115 and 125 may be suppressed.

In addition, the sensor-side surface of the fifth lens 105, 115 and 125 may have a curvature radius (absolute value) of 50 mm or more, for example, 100 mm or more, on the optical axis. Accordingly, the fifth lens can refract incident light to the entire area of the image sensor 300, and improve distortion and aberration characteristics in the center and periphery of the image sensor. In addition, light may be uniformly refracted to the center and periphery of the image sensor 300 through the long BFL area between the fifth lens and the image sensor 300.

1<TLG1/TLG2<4 [Mathematical expression 3]

TLG1 means the optical axis distance of the first lens group, and is preferably the optical axis distance from the center of the object-side surface of the first lens to the center of the sensor-side surface of the third lens. TLG2 means the optical axis distance of the second lens group, and is preferably the optical axis distance from the center of the object-side surface of the fourth lens to the center of the sensor-side surface of the fifth lens. When the optical system satisfies Mathematical expression 3, a folded-type optical system having a BFL of 5 mm or more when photographing at infinity may be provided.

0.50<CA52/CA11<1 [Mathematical expression 4]

CA52 means the maximum effective length of the sensor-side surface of the fifth lens 105, 115 and 125, and CA11 means the maximum effective length of the object-side surface of the first lens 101, 111 and 121. This mathematical expression 4 may be a condition for the first lens 101 having the largest effective length to be non-circular, for example, the effective length in the second direction perpendicular to the optical axis may be cut into a shape smaller than the effective length in the first direction. Accordingly, since the first lens has a D-cut shape, the thickness of the camera module mounted in the thickness direction of the portable electronic device may be reduced. Here, it is preferable that 0.50<CA52/CA11<0.9 be satisfied. If it is smaller than the range of mathematical expression 4, the characteristics of RI (Relative illumination) and MTF (Modulation transfer function) may be degraded. In addition, when both ends of the object-side surface and the sensor-side surface of the first lens 101 in the second direction are cut, mathematical expression 4-1 may satisfy: 0.55<CA52/CA12<1. If the conditions of Mathematical expressions 4 and 4-1 are satisfied, the height or thickness of the camera module in the second direction may be reduced, and the thickness of a mobile terminal including such a camera module may not increase.

5 mm<(CA51+CA52)<12 mm [Mathematical expression 5]

CA51 represents the effective diameter of the object-side surface of the fifth lens 105, 115 and 125, and CA52 represents the effective diameter of the sensor-side surface of the fifth lens. For optical performance and assembly, the fifth lens is a circular lens. Mathematical expression 5 can set the effective diameter of the last lens when at least one of the first to third lenses is cut at both ends in the thickness direction of the mobile terminal. Preferably, the condition may include: 6 mm<(CA51+CA52)<11 mm or 7.5 mm<(CA51+CA52)<10 mm.

ImgH<CA51<2*ImgH Mathematical expression 6-1:

ImgH<CA52<2*ImgH Mathematical expression 6-2:

ImgH<CA5<2*ImgH Mathematical expression 6-3:

Here, ImgH is half the diagonal length of the image sensor, and CA5 is the average value of CA51 and CA52.

1.62≤Nd3<1.8 [Mathematical expression 6]

Nd3 is the refractive index of the third lens 103, 113 and 123 at the d-line. By increasing the refractive index of the third lens in Mathematical expression 6, factors affecting the reduction of third-order aberrations (Seidel aberrations) in the optical system may be controlled, thereby reducing aberrations that may occur with a slightly longer TTL. Mathematical expression 6 preferably satisfies 1.65≤Nd3<1.7. If the design is lower than the lower limit of Mathematical expression 6, aberrations may be reduced to achieve performance, but the power of the third lens 103 may be weakened, degrading the performance of the optical system. If the refractive index of the third lens is designed to be lower than the lower limit of Mathematical expression 6, the curvature radius of the third lens must be increased to increase its power.

1.60≤Nd5<1.7 [Mathematical expression 6-1]

Nd4<Nd3 [Mathematical expression 6-2]

Nd1,Nd2<1.60 [Mathematical expression 6-3]

Here, Nd5 is the refractive index of the fifth lens 105, 115 and 125 at the d-line, and Nd4 is the refractive index of the fourth lens 104, 114 and 124 at the d-line. By setting the refractive indices of the third, fourth, and fifth lenses, chromatic dispersion may be controlled. Additionally, Nd1 and Nd2 are the refractive indices of the first and second lenses at the d-line, and by setting them to less than 1.60, chromatic dispersion of incident light may be suppressed.

CA1x≠CA1y [Mathematical expression 7]

CA1x and CA1y mean that the effective length CA1x in the first direction X and the effective length CA1y in the second direction Y of the first lens 101, 111 and 121 are set differently. Accordingly, when mathematical expression 7 is satisfied, the thickness of the folded-type optical system and the camera module including the same may be reduced.

0.55<CA11y/CA11x<1 [Mathematical expression 8]

Here, CA11x is the effective length of the object-side surface of the first lens 101 in the first direction, and CA11y is the effective length of the object-side surface of the first lens 101 in the second direction. When mathematical expression 8 satisfies the above range, the object-side surface of the first lens may be set as a lens with both ends cut in the second direction, thereby reducing the thickness of the optical system. In addition, when the range of mathematical expression 8 is less than the lower limit, the lens cutting ratio may decrease, which may complicate the process.

1<CT1/CT5<3 [Mathematical expression 9]

Mathematical expression 9 sets the difference between the center thicknesses CT1 and CT5 of the first and fifth lenses, thereby facilitating the control of the optical path of the optical system and improving the optical performance of the central and peripheral portions of the field of view (FOV). Preferably, 1.1<CT1/CT5<2 may be satisfied. When Mathematical expression 9 is satisfied, the aberration characteristics may be improved and the influence on the reduction of the optical system may be controlled. Accordingly, the chromatic aberration of the optical system may be improved, and excellent optical performance may be achieved at the set field of view and the TTL may be controlled. In addition, the center thickness CT3 of the third lens 103, 113 and 123 may be thinner than the center thickness CT1 of the first lens 101, 111 and 121. The center thickness CT3 of the third lens 103 may be thinner than the center thickness CT2 of the second lens 102.

0.3<CG3/CT123<1 [Mathematical expression 10]

CG3 is the center distance between the third and fourth lenses when photographing at infinity, and CT123 is the sum of the center thicknesses of the first, second, and third lenses. In Mathematical expression 10, by setting the center distance of the third and fourth lenses to be smaller than the sum of the center thicknesses of the first, second, and third lenses, for example, within the above range, light collected by the first lens group LG1 may be dispersed and guided through the second lens group LG2. The aperture stop ST may be disposed on the perimeter of the object-side surface or the sensor-side surface of the third lens 103, 113 and 123. When the second lens group LG2 is moved, the optical axis distance CG3′ between the third and fourth lenses may satisfy the following condition:

1.5<Max_CG3′/CG3<3 [Mathematical expression 10-1]

Max_CG3′ is the optical axis distance between the third and fourth lenses when the second lens group LG2 is moved to its maximum. Preferably, 1.7<Max_CG3′/CG3<2.5 may be satisfied. The optical axis distance CG3 between the third and fourth lenses during infinite photographing is minimum and may be 1.8 mm or more, for example, in the range of 2.0 mm to 2.55 mm. When photographing at a near distance of 800 mm or less, which is less than infinity, it can gradually increase.

1<CG3/CT45<2 [Mathematical expression 11]

CT45 is the sum of the center thicknesses of the fourth and fifth lenses. In Mathematical Expression 11, the center distance CG3 of the third and fourth lenses is set to be greater than the sum of the center thicknesses of the fourth and fifth lenses, thereby securing the optical axis distance between the second lens group and the image sensor 300. Preferably, 1.1<CG3/CT45<1.8 may be satisfied.

0.5 mm<CG3<5 mm [Mathematical Expression 12]

Mathematical Expression 12 allows the optical axis distance CG3 between the third and fourth lenses to be set to a value ranging from infinity to near distance. Preferably, the range is 2 mm<CG3<5 mm.

1<BFL/TLG2<4 [Mathematical Expression 13]

TLG2 is the optical axis distance of the second lens group, i.e., the optical axis distance from the center of the object-side surface of the fourth lens 104 to the center of the sensor-side surface of the fifth lens 105. When Mathematical Expression 13 is satisfied, the focal length of the folded-type zoom optical system may be adjusted. Preferably, 2<BFL/TLG2<4 may be satisfied.

1<BFL/TLG1<3 [Mathematical Expression 12-1]

BFL is an optical axis distance between the object-side surface of the fifth lens 105 and the image sensor 300, i.e., the maximum optical axis distance. TLG1 is an optical axis distance of the first lens group, i.e., the optical axis distance from the center of the object-side surface of the first lens to the center of the sensor-side surface of the third lens. When Mathematical Expression 12-1 is satisfied, the focal length of the folded-type zoom optical system may be adjusted. Preferably, 1.5<BFL/TLG1<2.5 may be satisfied.

1<CA11/CA41<3 [Mathematical expression 14]

CA11 represents the effective length of the first surface S1 of the first lens 101, i.e., the effective length in the first direction, and CA41 represents the effective diameter of the seventh surface S7 of the fourth lens 104. When Mathematical expression 14 is satisfied, incident light may be controlled and factors affecting aberration may be set. Preferably, 1.1<CA11/CA41<2 may be satisfied. Since the first and fourth lenses satisfy Mathematical expression 14, the difference in effective lengths of the first and fourth lenses is not significant, thereby reducing the influence of assembly and optical characteristics.

0<CA32/CA41<2 [Mathematical Expression 15]

CA32 means the effective length of the sixth surface S6 of the third lens 103, i.e., the maximum effective length, and CA41 means the effective diameter of the seventh surface S7 of the fourth lens 104. When Mathematical Expression 15 is satisfied, the camera module 1000 can control light traveling from the first lens group LG1 to the second lens group LG2 and can set a factor affecting a decrease in lens sensitivity. Preferably, Mathematical Expression 15 may satisfy: 0.5<CA32/CA41<1.2. Mathematical Expression 15 can set the effective lengths of two lens surfaces facing each other within the first and second lens groups.

0<CA41/CA52<2 [Mathematical expression 16]

CA41 represents the effective diameter of the object-side surface of the fourth lens 104, and CA52 represents the effective diameter of the tenth surface S10 of the fifth lens 105. If the camera module 1000 according to the embodiment satisfies Mathematical expression 16, the effective diameters of the incident and exit lenses of the second lens group may be set. Preferably, 0.5<CA41/CA52<1 may be satisfied. Since the effective lengths of the fourth and fifth lenses satisfy Mathematical expression 16, a slim folded optical system may be provided.

0.5<BFL/CA1<3 [Mathematical expression 17]

CA1 represents the average of the maximum effective lengths of the object-side and sensor-side surfaces of the first lenses 101, 111, and 121. If mathematical expression 17 is satisfied, the BFL, which is the optical axis distance between the last lens and the image sensor when photographing at infinity, may be set, and a folded-type zoom optical system may be provided. Preferably, 1<BFL/CA1<1.5 may be satisfied.

1<BFL/CA5<3 [Mathematical expression 18]

CA5 is the average of the effective diameters of the object-side and sensor-side surfaces of the fifth lens 105, 115 and 125. If Mathematical expression 18 is satisfied, the BFL, which is the optical axis distance between the fifth lens and the image sensor 300 during infinity shooting, may be set, and a folded-type zoom optical system may be provided. Preferably, 1<BFL/CA5<2 may be satisfied.

2<BFL/CG3<5 [Mathematical expression 19]

If Mathematical expression 19 is satisfied, the center distance between the first and second lens groups and the BFL, which is the optical axis distance between the fifth lens 105, 115 and 125 and the image sensor 300 during infinity shooting, may be set, and a folded-type zoom optical system may be provided. That is, BFL is the maximum optical axis distance between the fifth lens 105, 115 and 125 and the image sensor 300, and CG3 may be the minimum center distance between the first and second lens groups. Here, when the second lens group LG2 moves to the maximum, ImgH<Max_CG3′ may be satisfied. When photographing at a distance of 800 mm from the subject, ImgH>CG3′ (800) may be satisfied. In addition, when photographing at a distance of 400 mm or more from the subject, the condition satisfies: ImgH>CG3′ (400 or more), and when it is less than 400 mm, the condition may satisfy: ImgH<CG3′ (less than 400).

0.1<TLG1/TTL<0.5 [Mathematical expression 20]

TTL means the optical axis distance from the object-side surface of the first lens 101 to the image surface of the image sensor 300. If the optical system satisfies Mathematical expression 20, the optical axis distance of the first lens group LG1 relative to the total length (TTL) may be set to set the effective diameter, curvature radius, refractive index, Abbe number, etc. of the lenses within the first lens group. Preferably, 0.15<TLG1/TTL<0.3 may be satisfied.

0<TLG2/TTL<0.3 [Mathematical expression 21]

If the optical system satisfies Mathematical expression 21, the optical axis distance of the second lens group LG2 relative to the total length (TTL) may be set to set the effective diameter, curvature radius, refractive index, Abbe number, etc. of the lenses within the second lens group. Preferably, 0<TLG2/TTL<0.2 may be satisfied.

0<|L2R1/L5R2|<0.5 [Mathematical expression 22]

L2R1 represents the curvature radius of the third surface of the second lens 102, 112 and 122, and L5R2 represents the curvature radius of the tenth surface of the fifth lens 105, 115 and 125. In Mathematical expression 22, the power of the second and fifth lenses may be controlled by setting the curvature radius of the object-side surface of the second lens and the sensor-side surface of the fifth lens. Accordingly, good optical performance may be achieved at the center and periphery of the field of view. Preferably, Mathematical expression 22 may satisfy: 0<|L2R1/L5R2|<0.1.

1<L5R1/CT5<10 [Mathematical expression 23]

L5R1 represents the curvature radius of the object-side surface of the fifth lens 105, 115 and 125, and CT5 represents the center thickness of the fifth lens 105. When Mathematical expression 23 is satisfied, the power of the fifth lens may be controlled to control the incident light through the aspherical lens, thereby preventing deterioration of the aspherical lens assembly. Preferably, 3<L5R1/CT5<8 may be satisfied.

0<L3R2/|L4R1|<2 [Mathematical expression 24]

L3R2 represents the curvature radius of the sensor-side surface of the third lens 103, 113 and 123, and L4R1 represents the curvature radius of the object-side surface of the fourth lens 104. If Mathematical expression 24 is satisfied, the shape and curvature radius of the lens surfaces of the two facing lenses within the first and second lens groups may be adjusted to control light dispersion. Preferably, 0.5<L3R2/|L4R1|<1.2 may be satisfied.

0<|L4R1/L4R2|<1 [Mathematical expression 25]

L4R1 represents the curvature radius of the object-side surface of the fourth lens 104, 114 and 124, and L4R2 represents the curvature radius of the sensor-side surface of the fourth lens. If Mathematical expression 25 is satisfied, the sensitivity to light may be reduced by adjusting the curvature radius of the lens located at the center of the optical system. Preferably, 0<|L4R1/L4R2| <0.5 may be satisfied.

1<L3R1/L3R2<7 [Mathematical expression 25-1]

The curvature radii L3R1 of the object-side surface and the sensor-side surface L3R2 of the third lens 103, 113 and 123 are set. If these values are satisfied, the curvature radii of the third lens located at the center of the optical system may be adjusted to lower the light sensitivity.

1<TTL/TD<3 [Mathematical expression 26]

TD is an optical axis distance from the object-side surface of the first lens 101, 111 and 121 to the sensor-side surface of the last lens. TD is the optical axis distance from the center of the first surface S1 of the first lens to the tenth surface S10 of the fifth lens 105, 115 and 125. Preferably, the range is 1.5<TTL/TD<2.2. If the optical system satisfies Mathematical expression 26, a long BFL may be secured by setting the TTL vs. TD. This allows for a folded-type zoom optical system.

2<TTL/CA_Max<6 [Mathematical expression 27]

CA_Max means the largest effective length (mm) among the object-side and sensor-side surfaces of the plurality of lenses. Mathematical expression 27 establishes the relationship between the overall optical axis length and the maximum effective length of the optical system, thereby enabling the establishment of a folded-type zoom optical system. Mathematical expression 27 preferably satisfies 2<TTL/CA_Max<3.

3<TTL/ImgH<8 [Mathematical expression 28]

Mathematical expression 28 can set the overall optical axis length (TTL) of the optical system and the diagonal length (ImgH) of the optical axis of the image sensor 300. When the camera module 1000 according to the embodiment satisfies Mathematical expression 28, the camera module 1000 may have an image sensor smaller than the TTL size for application of the image sensor 300, thereby providing a folded-type optical system. Mathematical expression 28 preferably satisfies 3<TTL/ImgH<6.

1<BFL/ImgH<4 [Mathematical expression 29]

Mathematical expression 29 can set the optical axis distance between the image sensor 300 and the last lens, i.e., the maximum optical axis distance (BFL), and the diagonal length (ImgH) from the optical axis of the image sensor 300. When the camera module 1000 according to the embodiment satisfies mathematical expression 29, the camera module 1000 can secure a long BFL (Back focal length) compared to the size of the image sensor 300, can set the distance between the last lens and the image sensor 300 to a teletype, and may have good optical characteristics at the center and periphery of the FOV. Mathematical expression 29 preferably satisfies the condition: 1.5<BFL/ImgH<3, and BFL<(ImgH*2). Here, when the second lens group LG2 moves to the maximum, ImgH<Min_BFL1 may be satisfied. When photographing at a distance of 800 mm from the subject, ImgH<BFL1 (800) may be satisfied.

0.2<BFL/TTL<1 [Mathematical expression 30]

Mathematical expression 30 can set the total optical axis length (TTL of the optical system and the optical axis distance between the image sensor 300 and the last lens, i.e., the maximum optical axis distance (BFL). If the camera module 1000 according to the embodiment satisfies Mathematical expression 30, the camera module 1000 can secure a long BFL. Mathematical expression 30 preferably satisfies 0.2<BFL/TTL<0.65.

0.5<TTL/F<1.5 [Mathematical expression 31]

Mathematical expression 31 can set the total focal length F and total optical axis length TTL of the camera module 1000, thereby providing a folded-type zoom optical system. Mathematical expression 31 preferably satisfies: 0.7<TTL/F<1. When the camera module 1000 according to the embodiment satisfies mathematical expression 31, the camera module 1000 may have a tele-type focal length in a set TTL range, and provides an optical system capable of forming an image while maintaining the tele-type focal length. When it is below the lower limit of mathematical expression 31, it is necessary to increase the power of the lenses, which makes it difficult to correct spherical aberration or distortion aberration, and when it exceeds the upper limit of mathematical expression 31, the effective diameter or TTL of the lenses may become longer, which may cause a problem in that the imaging lens system becomes larger.

0<CT_Max/CG_Max<1 [Mathematical expression 32]

In Mathematical expression 32, the maximum center thickness CT_Max among the lenses and the maximum center distance CG_Max between adjacent lenses may be set. When Mathematical expression 32 is satisfied, the optical system can exhibit good optical performance at the set focal length and FOV and can reduce the TTL. Preferably, the embodiment satisfies: 0.3<CT_Max/CG_Max<0.85.

0.5<ΣCT/ΣCG<3 [Mathematical expression 33]

In Mathematical expression 33, ΣCT is the sum of the center thicknesses of the lenses, and ΣCG is the sum of the center distances between adjacent lenses. When Mathematical expression 33 is satisfied, the optical system can exhibit good optical performance at the set focal length and FOV and can reduce the TTL. Preferably, the embodiment may satisfy: 1<ΣCT/ΣCG<2.

5<ΣNd<11 [Mathematical expression 34]

ΣNd means the sum of the refractive indices at the d-line of each of the plurality of lenses. When Mathematical expression 34 is satisfied, the TTL may be controlled in a tele-type camera module 1000 and improved resolution may be achieved. Mathematical expression 34 can preferably satisfy: 6<ΣNd<10.

10<ΣVd/ΣNd<50 [Mathematical expression 35]

ΣVd means the sum of the Abbe numbers of each of the plurality of lenses. When Mathematical expression 35 is satisfied, the camera module 1000 may have improved aberration characteristics and resolution. By setting the sum of the Abbe numbers and the sum of the refractive indices of the lenses in Mathematical expression 35, optical characteristics may be controlled, preferably satisfying 15<ΣVd/ΣNd<30.

0.5<CA11/CA_Min<2.5 [Mathematical expression 36]

CA11 represents the effective length of the object-side surface of the first lens, e.g., the effective length in the first direction, and CA_Min represents the minimum effective length between the object-side and sensor-side surfaces of the lenses. When Mathematical expression 36 is satisfied, the optical system can control incident light, maintain optical performance, and provide a slimmer module. Mathematical expression 36 preferably satisfies 1<CA11/CA_Min<2.

0.3<CG3/CA_Min<2.5 [Mathematical expression 37]

If Mathematical expression 37 is satisfied, the path of light traveling between the first and second lens groups LG1 and LG2 may be effectively controlled. Mathematical expression 37 preferably satisfies: 0.4<CG3/CA_Min<1.

1<CA_Max/CA_Aver<3 [Mathematical expression 38]

CA_Aver represents the average effective length of the object-side and sensor-side surfaces of all lenses. If Mathematical expression 38 is satisfied, the optical system may be sized for a slim and compact structure while maintaining optical performance. Mathematical expression 38 preferably satisfies: 1<CA_Max/CA_Aver<1.5.

20<CA_Max*nL<50 [Mathematical expression 39]

nL represents the number of lenses in the optical system, and may be, for example, 5. When Mathematical Expression 39 is satisfied, the optical system can set the maximum effective length based on the total number of lenses. Mathematical Expression 39 preferably satisfies: 24<CA_Max*nL<35.

0<CA_Max/(2*ImgH)<2 [Mathematical Expression 40]

Mathematical Expression 40 may be set based on the maximum effective length CA_Max of the lens surfaces and the diagonal length of the image sensor. When this is satisfied, the optical system can maintain good optical performance and be sized for a slim and compact structure. Preferably, 0.5<CA_Max/(2*ImgH)<1.

1<TD/CA_Max<4 [Mathematical Expression 41]

When Mathematical Expression 41 is satisfied, the total optical axis distance TD of the lenses and the maximum effective length of the lens surfaces may be set, thereby setting the size for good optical performance. Mathematical expression 41 preferably satisfies: 1<TD/CA_Max<2.

0<CT_Max/TD<0.5 [Mathematical expression 42]

Mathematical expression 42 sets the maximum center thickness and the total optical axis distance TD of the lenses, thereby improving optical performance. Preferably, 0<CT_Max/TD<0.35 may be satisfied.

1<F/CA51<10 [Mathematical expression 43]

F represents the effective focal length (EFL) of the optical system and may be greater than 7 mm. Mathematical expression 43 sets the relationship between the effective focal length and the effective diameter of the object-side surface of the last spherical lens, thereby controlling the effect on optical system demagnification, such as TTL. Mathematical expression 43 preferably satisfies: 1<F/CA51<5.

1<F/L1R1<10 [Mathematical expression 44]

In Mathematical expression 44, the effective focal length of the optical system and the curvature radius of the object-side surface of the first lens are set, allowing for adjustment of the influence on incident light and TTL. Mathematical expression 44 preferably satisfies: 2<F/L1R1<6.

2<Max(CT/ET)<4 [Mathematical expression 45]

Max (CT/ET) represents the maximum value of the ratio of the center thickness to the edge thickness of each lens. When Mathematical expression 45 is satisfied, the optical system can adjust the influence on the effective focal length. Mathematical expression 45 preferably satisfies: 2<Max (CT/ET)<3.5.

1<EPD/L1R1<2 [Mathematical expression 46]

EPD means the size (mm) of the entrance pupil diameter of the camera module 1000. When the camera module 1000 according to the embodiment satisfies Mathematical expression 46, the camera module 1000 can control incident light. Mathematical expression 46 preferably satisfies: 1.2<EPD/L1R1<1.8.

1<|F1/F3|<5 [Mathematical expression 47]

F1 is the focal length of the first lens 101, and F3 is the focal length of the third lens 103. When Mathematical expression 47 is satisfied, the power of the first and third lenses may be controlled to improve resolution and affect the TTL and effective focal length F. Preferably, 1<F1/F3|<2 may be satisfied.

The aperture stop ST is disposed on the object-side or sensor-side surface of the third lens 103. The focal length of the lens positioned closer to the sensor than the aperture stop ST and closest to the aperture stop ST is less than 0. In an embodiment of the present invention, the focal lengths F3 and F4 of the third and fourth lenses should be designed to be less than 0. In this case, since the fourth lens has a concave shape on both sides, the optical axis distance between the third and fourth lenses may be increased, and the distance between the fourth and fifth lenses may be reduced, thereby preventing an increase in the effective diameter of the third and fourth lenses. The composite focal length F45 of the fourth and fifth lenses may have negative power. That is, the composite focal length F45 of the lenses positioned closer to the sensor than the aperture stop ST is designed to be less than 0. In this case, a telephoto optical system may be provided.

|Po4|<Po5 [Mathematical expression 48]

Po4 is the power value of the fourth lens 104, and Po5 is the power value of the fifth lens 105. The power of the fifth lens is positive, and the power of the fourth lens is negative, so the fifth lens can compensate for the aberrations occurring in the third and fourth lenses.

15<Vd2−Vd3<60 [Mathematical expression 49]

Vd2 is the Abbe number of the second lens, and Vd3 is the Abbe number of the third lens. When Mathematical expression 49 is satisfied, the difference in Abbe numbers between adjacent two lenses may be maintained above a certain value, thereby improving chromatic aberration. Mathematical expression 49 preferably satisfies: 30<Vd2−Vd3<45.

1<|F25/F12|<10 [Mathematical expression 50]

In Mathematical expression 50, the relationship between the composite focal length F12 of the first and second lenses and the composite focal length F25 of the second through fifth lenses is established, thereby controlling the power of each lens to improve resolution and provide a slim and compact optical system. Mathematical expression 50 preferably satisfies: 1<|F25/F12|<6.

1<|F25/F|<10 [Mathematical expression 51]

In Mathematical expression 51, the relationship between the overall focal length F and the composite focal length F25 of the second through fifth lenses is established, thereby controlling the power of each lens to improve resolution. Mathematical expression 51 preferably satisfies: 1<|F25/F|<2.

0<|F35|/F12|<2 [Mathematical expression 52]

In Mathematical expression 52, the relationship between the composite focal lengths F12 of the first and second lenses and the composite focal lengths F35 of the third to fifth lenses is established, thereby controlling the composite power of each lens to improve resolution. Mathematical expression 52 preferably satisfies: 0.5<|F35/F12|<1.5.

1<|F45|/F13<10 [Mathematical expression 53]

In Mathematical expression 53, the relationship between the composite focal lengths F13 of the first to third lenses and the composite focal lengths F45 of the fourth and fifth lenses is established, thereby controlling the composite power of each lens to improve resolution. Mathematical Expression 53 preferably satisfies: 1<|F45|/F13<5.

−130 mm<FLG2<−10 mm [Mathematical Expression 54]

FLG2 represents the focal length of the second lens group and may have a negative value. When within the range of Mathematical Expression 53, the focal length of the second lens group LG2 may be constrained, thereby limiting the amount of movement of the second lens group LG2. Preferably, the range is −80 mm<FLG2<−15 mm.

1<Fno<4 [Mathematical Expression 55]

Fno represents the F-number of the optical system. When Mathematical Expression 55 is satisfied, the brightness of the folded-type zoom optical system may be adjusted. Preferably, 2.4<Fno<3 may be satisfied.

2<BFL/Fno<4 [Mathematical expression 55-1]

The relationship between the F-number of the optical system and the BFL may be established.

1<ImgH/Fno<2 [Mathematical expression 55-2]

The relationship between the F-number of the optical system and half the diagonal length of the image sensor may be established.

7 mm<TTL<26 mm [Mathematical expression 56]

TTL means the distance from the center of the first surface S1 of the first lens 101 to the surface of the image sensor 300 along the optical axis OA. By setting the TTL in Mathematical expression 56 to be 10 mm or greater, a folded-type zoom optical system may be provided. Preferably, 10 mm≤TTL≤20 mm may be satisfied.

2 mm<ImgH [Mathematical expression 57]

Mathematical expression 57 can set half of the diagonal length of the image sensor 300 and can provide the size of the image sensor of a telephoto zoom optical system. Preferably, Mathematical expression 57 satisfies: 3 mm<ImgH<4.3 mm.

5 mm<BFL<12 mm [Mathematical expression 58]

In Mathematical expression 58, the BFL (Back Focal Length) is set to be greater than 5 mm and less than 12 mm, thereby securing the installation space for the optical filter 400 and the length for the telephoto optical system. Furthermore, the gap between the image sensor 300 and the final lens improves the assembling of components and enhances joint reliability. Mathematical expression 58 preferably satisfies: 5.5 mm<BFL<10 mm.

0<CT_Max/BFL<0.5 [Mathematical expression 59]

Mathematical expression 59 establishes the relationship between the thickest center thickness within the lens and the BFL. Mathematical expression 58 satisfies: 0.1<CT_Max/BFL<0.4.

70 mm<F(35)<180 mm [Mathematical expression 60]

The 35 mm equivalent focal length F(35) of Mathematical expression 60 may be set to suit a folded-type zoom optical system.

7 mm<F<25 mm [Mathematical expression 60-1]

F is the total effective focal length. Preferably, 12 mm<F<20 mm may be satisfied.

8 degrees<FOV<40 degrees [Mathematical expression 61]

In Mathematical expression 61, the FOV (Field of View) means the diagonal FOV (Degree) of the camera module 1000, and a telescopic optical system of less than 40 degrees may be provided. Preferably, 15 degrees<FOV<30 degrees may be satisfied.

1<FOV/BFL<5 [Mathematical expression 62]

In Mathematical expression 62, the FOV is set to be less than 5 times the BFL, thereby providing a telescopic optical system of less than 40 degrees. Preferably, 2<FOV/BFL<4.5 may be satisfied.

1<F/BFL<10 [Mathematical Expression 63]

Mathematical Expression 63 can set the total effective focal length F of the camera module 1000 and the optical axis distance (BFL) between the image sensor 300 and the last lens. When the camera module 1000 according to the embodiment satisfies Mathematical Expression 63, the camera module 1000 may have a set FOV, an appropriate focal length, and may be provided with a tele-type zoom optical system. In addition, the camera module 1000 can adjust the distance between the last lens and the image sensor 300, thereby providing good optical characteristics in the periphery of the field of view (FOV). Mathematical Expression 63 may preferably satisfy: 1<F/BFL<5.

1<F/ImgH<10 [Mathematical expression 64]

Mathematical expression 64 can set the overall effective focal length F of the camera module 1000 and the diagonal length ImgH from the optical axis of the image sensor 300. This camera module 1000 may have improved aberration characteristics within a folded-type zoom optical system. Preferably, Mathematical expression 64 may satisfy: 3<F/ImgH<7.

1<F/EPD<5 [Mathematical expression 65]

Mathematical expression 65 can set the overall effective focal length F and entrance pupil diameter of the camera module 1000. Accordingly, the overall brightness of the optical system may be controlled. Preferably, Mathematical expression 64 may satisfy: 2<F/EPD<3.5.

0.5<BFL/TD<1.5 [Mathematical expression 66]

Mathematical expression 66 can set the relationship between the optical axis distance TD of the lenses and the back focal length (BFL) of the camera module 1000. Accordingly, the overall size of the optical system may be controlled while maintaining the resolution. Preferably, Mathematical expression 66 satisfies: 0.6<BFL/TD<1.2, and preferably, the relationship TD>BFL. If the conditional value of BFL/TD exceeds 1.5, the TD is designed to be small relative to the BFL, reducing the overall size of the optical system. This can lead to deterioration of aberration characteristics or reduced resolution.

0<EPD/ImgH/FOV<0.2 [Mathematical expression 67]

Mathematical expression 67 can set the relationship between the EPD, the length of half (ImgH) of the diagonal length of the image sensor, and the diagonal FOV. Accordingly, the overall size and brightness of the optical system may be controlled. Mathematical expression 67 preferably satisfies: 0<EPD/ImgH/FOV<0.1.

1<FOV/Fno<20 [Mathematical expression 68]

Mathematical expression 68 can set the relationship between the diagonal FOV and the F-number of the optical system. Mathematical expression 68 preferably satisfies: 5<FOV/Fno<15. Here, Fno is provided to be less than 3.0, thereby providing a bright image.

0.1 mm<M1<3 mm [Mathematical expression 69]

M1 can set the stroke amount of the second lens group LG2 when photographing from infinity to close range with the subject.

0.1 mm<M1(800)<0.9 mm [Mathematical expression 69-1]

M1 (800) may satisfy Mathematical expression 69-1 when photographing a subject at a distance from infinity to 800 mm.

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + …$$

In Mathematical expression 80, Z represents Sag, which may refer to the distance along the optical axis from an arbitrary location on the aspherical surface to the vertex of the aspherical surface. Y may refer to the distance from an arbitrary location on the aspherical surface to the optical axis in a direction perpendicular to the optical axis. c may refer to the curvature of the lens, and K may refer to the conic constant. Additionally, A, B, C, D, E, and F may refer to aspheric coefficients from the 4th to the 14th order.

The camera module 1000 according to the embodiment may satisfy at least one or two or more mathematical expressions from Mathematical expressions 1 to 34. At least one or two or more of Mathematical expressions 1 to 34 may satisfy at least one or two or more of Mathematical expressions 35 to 69. In this case, the camera module 1000 may have improved optical characteristics. Specifically, when the camera module 1000 satisfies at least one of Mathematical expressions 1 to 34 and/or at least one of Mathematical expressions 35 to 69, the camera module 1000 may have improved resolution and may improve aberration and distortion characteristics. In addition, the camera module 1000 may secure a back focal length (BFL) for a telephoto optical system and may have good optical performance at the center and periphery of the FOV.

Table 4 shows the items of the Mathematical expressions described above in the camera module 1000 of the embodiment, including the TTL, BFL, effective focal length F, ImgH, TD (mm), which is the optical axis distance from the first surface S1 to the tenth surface S10, the focal lengths F1, F2, F3, F4, and F5 (mm) of each of the first to fifth lenses, the sum of the refractive indices, the sum of the Abbe numbers, the sum of the center thicknesses of each lens (mm), the sum of the distances between adjacent lenses, the diagonal FOV (Degree), the edge thickness ET, the focal lengths of the first and second lens groups, the composite focal lengths of the third, fourth, and fifth lenses, and the F number. The units of TTL, BFL, focal length, ImgH, TD, thickness, and distance are mm.

TABLE 4

| Items | Embodiment 1 | Embodiment 2 | Embodiment 3 |
|---|---|---|---|
| F | 16.000 | 16.00 | 16.00 |
| F1 | 11.060 | 11.32 | 12.15 |
| F2 | 12.640 | 12.21 | 11.07 |
| F3 | −9.515 | −9.38 | −9.19 |
| F4 | −7.480 | −8.29 | −6.89 |
| F5 | 11.524 | 13 | 9.83 |
| FLG1 | 11.60 | 11.88 | 11.85 |
| FLG2 | −26.41 | −26.77 | −29.89 |
| F12 | 6.37 | 6.46 | 6.36 |
| F34 | −3.68 | −3.88 | −3.46 |
| F35 | −6.89 | −6.77 | −6.99 |
| ET1 | 0.900 | 0.650 | 0.61 |
| ET2 | 0.364 | 0.310 | 0.30 |
| ET3 | 0.801 | 0.790 | 0.77 |
| ET4 | 1.153 | 0.910 | 0.87 |
| ET5 | 0.700 | 0.860 | 0.70 |
| Fno | 2.778 | 2.800 | 2.800 |
| FOV | 24.93 | 25 | 25 |
| (Diagonal) | | | |
| EPD | 5.760 | 5.76 | 5.76 |
| BFL | 6.378 | 6.30 | 6.83 |
| TD | 7.822 | 7.90 | 7.37 |
| ImgH | 3.539 | 3.6 | 3.6 |
| SD | 5.079 | 4.99 | 3.31 |
| TTL | 14.200 | 14.200 | 14.200 |
| ΣNd | 7.908 | 7.970 | 8.020 |
| ΣVd | 211.712 | 206.300 | 178.900 |
| ΣCT | 4.812 | 4.380 | 4.330 |
| ΣCG | 3.010 | 3.530 | 3.040 |
| ΣET | 3.919 | 3.520 | 3.250 |

Table 5 shows the results of Mathematical expressions 1 to 34 described above in the camera module 1000 of the embodiment. Referring to Table 5, it may be seen that the camera module 1000 satisfies at least one, two, or three or more of Mathematical expressions 1 to 34. Accordingly, the camera module 1000 may have good optical performance and superior optical characteristics in the center and periphery of the FOV.

[Table 5]

TABLE 5

| | | Embodi- | Embodi- | Embodi- |
|---|---|---|---|---|
| Mathematical expressions | | ment 1 | ment 2 | ment 3 |
| 1 | L1R1 > 0 | 3.867 | 3.740 | 3.540 |
| 2 | L4R2*L5R1 > 0 | Satis- | Satis- | Satis- |
| | | faction | faction | faction |
| 3 | 1 < TLG1/TLG2 < 4 | 1.415 | 1.582 | 1.607 |
| 4 | 0.50 < CA52/CA11 < 1 | 0.885 | 0.885 | 0.816 |
| 5 | 5 < (CA51 + CA52) < 12 | 9.830 | 9.600 | 8.880 |
| 6 | 1.65 ≤ Nd3 < 1.8 | 1.679 | 1.680 | 1.670 |
| 7 | CA1x ≠ CA1y | Satis- | Satis- | Satis- |
| | | faction | faction | faction |
| 8 | 0.55 < CA11y/CA11x < 1 | Satis- | Satis- | Satis- |
| | | faction | faction | faction |
| 9 | 1 < CT1/CT5 < 3 | 1.466 | 1.283 | 1.391 |
| 10 | 0.5 < CG3/(CT123) < 1.5 | 0.769 | 0.889 | 0.810 |
| 11 | 1 < CG3/(CT45) < 2 | 1.328 | 1.443 | 1.468 |
| 12 | 0.5 < CG3 < 5 | 2.343 | 2.410 | 2.260 |
| 13 | 1 < BFL/TLG2 < 4 | 2.811 | 2.958 | 3.485 |
| 14 | 1 < CA11/CA41 < 3 | 1.395 | 1.371 | 1.504 |
| 15 | 0 < CA32/CA41 < 2 | 0.947 | 0.924 | 0.974 |
| 16 | 0 < CA41/CA52 < 2 | 0.810 | 0.824 | 0.815 |
| 17 | 0.5 < BFL/CA1 < 3 | 1.158 | 1.143 | 1.244 |
| 18 | 1 < BFL/CA5 < 3 | 1.298 | 1.313 | 1.538 |
| 19 | 2 < BFL/CG3 < 5 | 2.722 | 2.614 | 3.022 |
| 20 | 0.1 < TLG1/TTL < 0.5 | 0.226 | 0.237 | 0.222 |
| 21 | 0 < TLG2/TTL < 0.3 | 0.160 | 0.150 | 0.138 |
| 22 | 0 < \|L2R1/L5R2\| < 0.5 | 0.001 | 0.040 | 0.031 |
| 23 | 1 < L5R1/CT5 < 10 | 6.023 | 6.842 | 6.300 |
| 24 | 0 < L3R2/\|L4R1\| < 2 | 0.889 | 0.962 | 0.907 |
| 25 | 0 < \|L4R1/L4R2\| < 1 | 0.352 | 0.125 | 0.263 |
| 26 | 1 < TTL/TD < 3 | 1.815 | 1.797 | 1.927 |
| 27 | 2 < TTL/CA_Max < 6 | 2.465 | 2.465 | 2.465 |
| 28 | 3 < TTL/ImgH < 8 | 4.012 | 4.000 | 4.000 |
| 29 | 1 < BFL/ImgH < 4 | 1.802 | 1.775 | 1.924 |
| 30 | 0.2 < BFL/TTL < 1 | 0.449 | 0.444 | 0.481 |
| 31 | 0.5 < TTL/F < 1.5 | 0.887 | 0.888 | 0.888 |
| 32 | 0 < CT_Max/CG_Max < 1 | 0.741 | 0.639 | 0.677 |
| 33 | 0.5 < ΣCT/ΣCG < 3 | 1.598 | 1.241 | 1.424 |
| 34 | 5 < ΣNd < 11 | 7.908 | 7.970 | 8.020 |

Table 6 shows the results of Mathematical expressions 35 to 69 described above in the camera module 1000 of the embodiment. Referring to Table 6, it may be seen that the camera module 1000 satisfies at least one, two, or three or more of Mathematical expressions 35 to 69. Accordingly, the camera module 1000 may have good optical performance and superior optical characteristics in the center and periphery of the field of view (FOV).

TABLE 6

| | | Embodi- | Embodi- | Embodi- |
|---|---|---|---|---|
| Mathematical expressions | | ment 1 | ment 2 | ment 3 |
| 35 | 10 < ΣVd/ΣNd < 50 | 26.772 | 25.885 | 22.307 |
| 36 | 0.5 < CA11/CA_Min < 2.5 | 1.473 | 1.485 | 1.544 |
| 37 | 0.3 < CG3/CA_Min < 2 | 0.599 | 0.621 | 0.606 |
| 38 | 1 < CA_Max/CA_Aver < 3 | 1.213 | 1.232 | 1.264 |
| 39 | 15 < CA_Max*nL < 40 | 28.800 | 28.800 | 28.800 |
| 40 | 0 < CA_Max/(2*ImgH) < 2 | 0.814 | 0.811 | 0.811 |
| 41 | 1 < TD/CA_Max < 4 | 1.358 | 1.372 | 1.280 |
| 42 | 0 < CT_Max/TD < 0.5 | 0.222 | 0.195 | 0.208 |
| 43 | 1 < F/CA51 < 10 | 3.383 | 3.556 | 3.828 |
| 44 | 1 < F/L1R1 < 10 | 4.138 | 4.278 | 4.520 |
| 45 | 2 < Max (CT/ET) < 4 | 2.317 | 2.369 | 2.533 |
| 46 | 1 < EPD/L1R1 < 2 | 1.490 | 1.540 | 1.627 |
| 47 | 1 < \|F1/F3\| < 5 | 1.162 | 1.207 | 1.322 |
| 48 | \|Po4\| < Po5 | Satis- | Satis- | Satis- |
| | | faction | faction | faction |
| 49 | 15 < Vd2 − Vd3 < 60 | 36.417 | 36.400 | 35.300 |
| 50 | 1 < \|F25/F12\| < 10 | 3.016 | 3.017 | 4.039 |
| 51 | 1 < \| F25/F \| < 10 | 1.200 | 1.218 | 1.606 |
| 52 | 0 < \|F35/F12\| < 2 | 1.082 | 1.048 | 1.099 |
| 53 | 1 < \|F45\|/F13 < 10 | 2.277 | 2.253 | 2.522 |
| 54 | −130 < FLG2 < −10 | −26.41 | −26.77 | −29.89 |
| 55 | 1 < Fno < 4 | 2.778 | 2.800 | 2.800 |
| 56 | 7 < TTL < 26 | 14.200 | 14.200 | 14.200 |
| 57 | 2 < ImgH | 3.539 | 3.550 | 3.550 |
| 58 | 5 < BFL < 12 | 6.378 | 6.300 | 6.830 |
| 59 | 0 < CT_Max/BFL < 0.5 | 0.272 | 0.244 | 0.224 |
| 60 | 70 < F(35 mm) < 180 | 16.000 | 16.000 | 16.000 |
| 61 | 8 < FOV < 40 | 24.93 | 24.70 | 24.90 |
| 62 | 1 < FOV/BFL < 5 | 3.909 | 3.921 | 3.646 |
| 63 | 1 < F/BFL < 10 | 2.509 | 2.540 | 2.343 |
| 64 | 1 < F/ImgH < 10 | 4.521 | 4.507 | 4.507 |
| 65 | 1 < F/EPD < 5 | 2.778 | 2.778 | 2.778 |
| 66 | 0.5 < BFL/TD < 1.5 | 0.815 | 0.797 | 0.927 |
| 67 | 0 < EPD/Imgh/FOV < 0.2 | 0.065 | 0.066 | 0.065 |
| 68 | 1 < FOV/Fno < 20 | 8.976 | 8.821 | 8.893 |
| 69 | 0.1 < M1 < 3 | Satis- | Satis- | Satis- |
| | | faction | faction | faction |

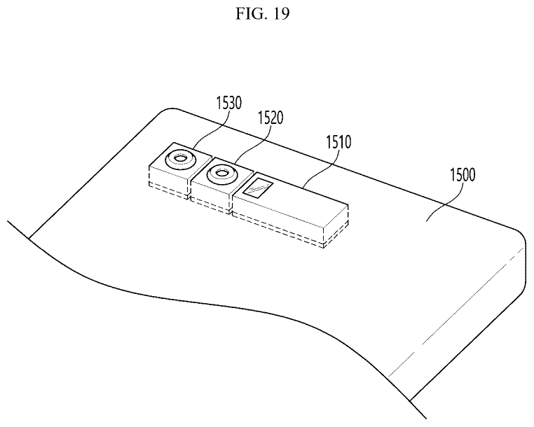

FIG. 19 is a drawing illustrating a camera module according to an embodiment applied to a portable electronic device, such as a mobile phone. As illustrated in FIG. 19, a portable electronic device 1500 according to an embodiment of the present invention includes a plurality of imaging optical systems, each of which includes a plurality of lenses. For example, the portable electronic device 1500 may include a first imaging optical system 1510, a second imaging optical system 1520, and a third imaging optical system 1530. The first imaging optical system 1510, the second imaging optical system 1520, and the third imaging optical system 1530 are configured to have different angles of view. The first imaging optical system 1510 may be configured to have the narrowest FOV (first telephoto, 3×), the second imaging optical system 1520 may be configured to have a wider FOV (second telephoto, 2×) than that of the first imaging optical system 1510, and the third imaging optical system 1530 may be configured to have the widest FOV (wide angle, 1×). For example, the FOV (FOV1) of the first imaging optical system 1510 may be 40 degrees>FOV1, the FOV (FOV2) of the second imaging optical system 1520 may be 40 degrees<FOV2, and the FOV (FOV3) of the third imaging optical system 1530 may be 75 degrees≤FOV3≤95°. By designing the angles of view of the three imaging optical systems differently, it is possible to capture images of a subject at various depths and implement a zoom function. In addition, it is possible to implement a zoom ratio of 3× without increasing the thickness of the portable electronic device 1000. In addition, since two images of a single subject may be used (for example, synthesized) to create a high-resolution image or a bright image, the subject image may be captured clearly even in low-light environments.

Meanwhile, at least one of the second imaging optical system 1520 and the third imaging optical system 1530 has the optical axis of the plurality of lenses formed in the thickness direction of the portable electronic device 1000 (from the front surface of the portable electronic device 1000 to the rear surface or the opposite direction), but the first imaging optical system 1510 having the narrowest FOV is arranged so that the optical axes of the plurality of lenses are perpendicular to the thickness direction of the portable electronic device 1000. That is, among the first imaging optical system 1510 to the third imaging optical system 1530, the direction of the optical axis of the imaging optical system having the narrowest FOV is formed differently from the directions of the optical axes of the other imaging optical systems. For example, the optical axis (Z-axis) of the plurality of lenses constituting the first imaging optical system 1510 may be formed in the width direction or the length direction of the portable electronic device 1000. The second imaging optical system 1520 or the third imaging optical system 1530 may be the camera module disclosed above.

Therefore, the overall length of the first imaging optical system 1510 may be configured so as not to affect the thickness of the portable electronic device 1000. Accordingly, miniaturization of the portable electronic device 1000 is possible. Since the first imaging optical system 1510 is arranged such that its optical axis is perpendicular to the thickness direction of the portable electronic device 1000, it is configured to change the path of light incident in the thickness direction of the portable electronic device 1000. For example, the first imaging optical system 1510 may include a reflective member 510 (See FIG. 1) having a reflective surface to change the optical path, and the reflective member 510 may be a mirror or prism capable of changing the optical path.

In addition, the portable electronic device 1500 may include a flash module (not shown) and an auto-focus device (not shown). Here, the auto-focus device (not shown) may include a surface-emitting laser element and a light receiving unit as a light-emitting layer. The flash module may include an emitter that emits light therein. The flash module may be operated by the camera operation of the electronic device or by the user's control. The auto-focus device may include an auto-focus function using a laser. The auto-focus device may be mainly used in conditions where the auto-focus function using the image of the camera module is degraded. In addition, although not shown in the drawing, at least one camera module may be further disposed on the front of the portable terminal 1500. At least one of the camera modules in the portable terminal may have a tele-type folded optical system disclosed above. The optical system or camera module according to the embodiment of the invention, the lens assembly according to various embodiments, may be applied to, for example, an electronic device employing an image sensor. The lens assembly according to the exemplary embodiment may be applied to various electronic devices, such as digital cameras, interchangeable lens cameras, video cameras, mobile phone cameras, cameras for small mobile devices, VR, AR, drones, and manned/unmanned aerial vehicles.

The features, structures, and effects described in the embodiments above are included in at least one embodiment of the present invention and are not necessarily limited to a single embodiment. Furthermore, the features, structures, and effects illustrated in each embodiment may be combined or modified in other embodiments by those skilled in the art to which the embodiments pertain. Therefore, such combinations and modifications should be construed as falling within the scope of the present invention.

Furthermore, while the embodiments have been described above, they are merely examples and not limitations of the present invention. Those skilled in the art will appreciate that various modifications and applications not illustrated above are possible without departing from the essential characteristics of the embodiments. For example, each component specifically illustrated in the embodiments may be modified and implemented. Furthermore, differences related to such modifications and applications should be construed as falling within the scope of the present invention defined in the appended claims.

1. An optical system comprising:
a reflective member having a reflective surface;
a first lens group having a plurality of lenses; and
a second lens group disposed on a sensor side of the first lens group, having a plurality of lenses and having negative power,
wherein the reflective member, the lenses of the first lens group, and the lenses of the second lens group are aligned along an optical axis,
wherein the first lens group includes a first lens having a maximum effective length, a second lens disposed on a sensor side of the first lens, and a third lens disposed on a sensor side of the second lens,
wherein an object-side surface of the first lens has a convex shape on the optical axis,
wherein a sensor-side surface of the first lens has a concave shape on the optical axis,
wherein the second lens group includes a fourth lens having a shape in which both sides are concave on the optical axis, and a fifth lens disposed on a sensor side of the fourth lens,
wherein a sensor-side surface of the fifth lens closest to an image sensor has a largest curvature radius among absolute values of curvature radii of object-side surfaces and sensor-side surfaces of the first to fifth lenses,
wherein an optical axis distance from the object-side surface of the first lens to a surface of the image sensor is TTL,
wherein an optical axis distance from the sensor-side surface of the fifth lens closest to the image sensor to the surface of the image sensor is BFL,
wherein an optical axis distance from the object-side surface of the first lens to the sensor-side surface of the fifth lens is TD, and
wherein the following mathematical expressions satisfy:
0.2<BFL/TTL<1, and
1<TTL/TD<3.

2. The camera module of claim 1,
wherein the first lens has positive power,
wherein the second lens has positive power, and
wherein the second lens group is configured to move along the optical axis.

3. The camera module of claim 2,
wherein a movement amount of the second lens group is M1,
wherein the following mathematical expression satisfies: 0.1 mm<M1<3 mm.

4. The camera module of claim 3,
wherein, when a distance between the first lens and a subject is 800 mm or more, the movement amount of the second lens group satisfies the mathematical expression: 0.1 mm<M1<0.9 mm.

5. The camera module of claim 1,
wherein a field of view of the camera module is less than 40 degrees.

6. The camera module of claim 1,
wherein a field of view of the camera module is less than 40 degrees, and
wherein a change in the field of view according to a maximum movement of the second lens group is 5 degrees or less.

7. The camera module of claim 1,
wherein, when a distance to a subject gradually decreases during photographing, an optical axis distance between the first lens group and the second lens group gradually increases and the BFL gradually decreases.

8. (canceled)

9. The camera module of claim 1,
wherein, when photographing at a minimum distance from a subject, an optical axis distance between the first and second lens groups is Max_CG3′, the optical axis distance between the fifth lens and the surface of the image sensor is Min_BFL1, and the following mathematical expression satisfies: 0.5<Min_BFL1/Max_CG3′<1.5.

10. A camera module comprising:
a reflective member having a reflective surface;
a first lens having positive power on an exit side of the reflective member;
a second lens on a sensor side of the first lens;
a third lens having negative power on a sensor side of the second lens;
a fourth lens on a sensor side of the third lens; and
a fifth lens on a sensor side of the fourth lens,
wherein the reflective member and the first to fourth lenses are aligned along an optical axis,
wherein powers of the fourth lens and the fifth lens have opposite signs,
wherein the first lens has a maximum effective length and includes an object-side surface that is convex on the optical axis,
wherein the fourth lens has a biconcave shape on the optical axis,
wherein a field of view of an optical system including the first to fifth lenses is less than 40 degrees,
wherein an optical axis distance from the center of the object-side surface of the first lens to the surface of an image sensor is TTL,
wherein half of a diagonal length of the image sensor is ImgH,
wherein an optical axis distance between the third and fourth lenses varies from a minimum of CG3 to a maximum of Max_CG3′,
wherein the following mathematical expressions satisfies:
1.5<Max_CG3′/CG3<3 and
2<TTL/ImgH<6.

11. The camera module of claim 10,
wherein the first to third lenses have a meniscus shape convex toward an object on the optical axis.

12. The camera module of claim 10,
wherein the fourth lens has negative power, and the fifth lens has positive power.

13. The camera module of claim 10,
wherein an optical axis distance between a sensor-side surface of the fifth lens and the image sensor varies depending on the optical axis distance between the third and fourth lenses.

14. The camera module of claim 10,
wherein a maximum optical axis distance between a sensor-side surface of the fifth lens and the image sensor is BFL, and the following mathematical expression satisfies: 1<BFL/ImgH<4.

15. The camera module of claim 10,
wherein a maximum optical axis distance between a sensor-side surface of the fifth lens and the image sensor is BFL, and the following mathematical expression satisfies: 0.2<BFL/TTL<1.

16. The camera module of claim 10,
wherein a maximum optical axis distance between a sensor-side surface of the fifth lens and the image sensor is BFL, and the following mathematical expression satisfies: 2<BFL/CG3<5.

17. The camera module of claim 10,
wherein a maximum effective length of object-side surfaces and sensor-side surfaces of the first to fifth lenses is CA_Max, and the following mathematical expression satisfies: 2<TTL/CA_Max<6.

18. The camera module of claim 10,
wherein a movement amount of the fourth and fifth lenses is M1,
wherein, when a distance from the subject is 800 mm or more,
the following mathematical expression satisfies: 0.1 mm<M1<0.9 mm.

19. The camera module of claim 10, comprising:
an aperture stop disposed around an object-side surface or a sensor-side surface of the third lens, and
wherein a change in a field of view due to a movement of the fourth and fifth lenses is 5 degrees or less.

20. The camera module of claim 10,
wherein, when photographing at a minimum distance from a subject, an optical axis distance between the third and fourth lenses is Max_CG3′, an optical axis distance between the fifth lens and the surface of the image sensor is Min_BFL1, and
wherein the following mathematical expression satisfies: 0.5<Min_BFL1/Max_CG3′<1.5.

21. The camera module of claim 2,
wherein the third lens has negative power, the fourth lens has negative power, and the fifth lens has positive power.
